(19) United States
(12) Patent Application Publication
(10) Pub. No.: US 2016/0233539 A1
(43) Pub. Date: Aug. 11, 2016

(54) SOLID STATE ENERGY STORAGE DEVICE

(71) Applicant: Sakti3, Inc., Ann Arbor, MI (US)

(72) Inventors: Ann Marie SASTRY, Ann Arbor, MI (US); Xiangchun ZHANG, Ann Arbor, MI (US); Chia-Wei WANG, Ypsilanti, MI (US); Yen-Hung CHEN, Ann Arbor, MI (US); Hyoncheol KIM, Ann Arbor, MI (US); Myoungdo CHUNG, Ann Arbor, MI (US)

(21) Appl. No.: 14/576,055

(22) Filed: Feb. 2, 2015

(51) Int. Cl. H01M 10/04; H01M 10/0565; H01M 4/58; H01M 10/0562; H01M 4/505; H01M 4/525

(52) U.S. Cl. CPC H01M 10/04; H01M 10/0431; H01M 4/505; H01M 4/525; H01M 4/5825; H01M 10/0562; H01M 10/0565; H01M 2220/20; H01M 2220/30; H01M 2220/10; H01M 2300/0082; H01M 2300/0068

(57) ABSTRACT

In an example, a solid-state battery apparatus is provided. The apparatus has a plurality of battery cell devices, each of the devices having an anode device, an electrolyte device, and a cathode device. The apparatus has an equivalent circuit (EC) numbered from 1 through N characterizing the plurality of battery cells devices, a state of charge characterizing the plurality of battery cell devices, and a resistor, capacitor, or other electrical parameters provided in the equivalent circuit.

### BACKGROUND OF THE INVENTION

This present disclosure relates to manufacture of electrochemical cells. More particularly, the present disclosure provides techniques, including a method and device, for a solid state battery device. Merely by way of example, the invention has been provided with use of lithium based battery cells, but it would be recognized that other battery cells made from materials such as zinc, silver and lead, nickel could be operated in the same or like fashion. Additionally, such batteries can be used for a variety of applications such as portable electronics (cell phones, personal digital assistants, radio players, music players, video cameras, and the like), tablet and laptop computers, power supplies for military use (communications, lighting, imaging, satellite, and the like), power supplies for aerospace applications (aero plane, satellites and micro air vehicles), power supplies for vehicle applications (hybrid electric vehicles, plug-in hybrid electric vehicles, fully electric vehicles, electric scooter, underwater vehicle, boat, ship, electric garden tractor, and electric ride on garden device), power supplies for remote control devices (unmanned aero drone, unmanned aero plane, an RC car), power supplies for a robotic appliances (robotic toys, robotic vacuum cleaner, robotic garden tools, robotic construction utility), power supplies for power tool (electric drill, electric mower, electric vacuum cleaner, electric metal working grinder, electric heat gun, electric press expansion tool, electric saw and cutters, electric sander and polisher, electric shear and nibbler, and routers), power supply for personal hygiene device (electric tooth brush, hand dryer and electric hair dryer), heater, cooler, chiller, fan, humidifier, power supplies for other applications (a global positioning system (GPS) device, a laser rangefinder, a flashlight, an electric street lighting, standby power supply, uninterrupted power supplies, and other portable and stationary electronic devices). The method and system for operation of such batteries are also applicable to cases in which the battery is not the only power supply in the system, and additional power is provided by a fuel cell, other batteries, an IC engine or other combustion devices, capacitors, solar cells, combinations thereof, and others.

Common electro-chemical cells often use liquid electrolytes. Such cells are typically used in many conventional applications. Alternative techniques for manufacturing electro-chemical cells include solid-state cells. Such solid state cells are generally in the experimental state, have been difficult to make, and have not been successfully produced in large scale. Although promising, solid state cells have not been achieved due to limitations in cell structures and manufacturing techniques. These and other limitations have been described throughout the present specification and more particularly below.

From the above, it is seen that techniques for improving the manufacture of solid state cells are highly desirable.

### BRIEF SUMMARY OF THE INVENTION

According to the present disclosure, techniques related to manufacture of electrochemical cells are provided. More particularly, the present disclosure provides techniques, including a method and device, for a solid state battery device. Merely by way of example, the invention has been provided with use of lithium based battery cells, but it would be recognized that other battery cells made from materials such as zinc, silver and lead, nickel could be operated in the same or like fashion. Additionally, such batteries can be used for a variety of applications such as portable electronics (cell phones, personal digital assistants, radio players, music players, video cameras, and the like), tablet and laptop computers, power supplies for military use (communications, lighting, imaging, satellite, and the like), power supplies for aerospace applications (aero plane, satellites and micro air vehicles), power supplies for vehicle applications (hybrid electric vehicles, plug-in hybrid electric vehicles, fully electric vehicles, electric scooter, underwater vehicle, boat, ship, electric garden tractor, and electric ride on garden device), power supplies for remote control devices (unmanned aero drone, unmanned aero plane, an RC car), power supplies for a robotic appliances (robotic toys, robotic vacuum cleaner, robotic garden tools, robotic construction utility), power supplies for power tool (electric drill, electric mower, electric vacuum cleaner, electric metal working grinder, electric heat gun, electric press expansion tool, electric saw and cutters, electric sander and polisher, electric shear and nibbler, and routers), power supply for personal hygiene device (electric tooth brush, hand dryer and electric hair dryer), heater, cooler, chiller, fan, humidifier, power supplies for other applications (a global positioning system (GPS) device, a laser rangefinder, a flashlight, an electric street lighting, standby power supply, uninterrupted power supplies, and other portable and stationary electronic devices). The method and system for operation of such batteries are also applicable to cases in which the battery is not the only power supply in the system, and additional power is provided by a fuel cell, other batteries, an IC engine or other combustion devices, capacitors, solar cells, combinations thereof, and others.

In an example, the cathode material can be deposited so as to produce observable discontinuities, taking the form of any combination of poly disperse generalized cones, which may variously, with changes in inclination of the conical surface relative to the substrate, be platelets, cones, inverted cones or right circular cylinders, surface discontinuities which variously appear as fissures, continuous or discontinuous polyhedral elements, holes, cracks or other defects, additive, deposited layers, any of the aforementioned geometries, in combination with three-dimensional, irregular, deposited poly-hedral structures, among others. Of course, there can be other variations, modifications, and alternatives.

Benefits are achieved over conventional techniques. Depending upon the specific embodiment, one or more of these benefits may be achieved. In a preferred embodiment, the present disclosure provides a suitable solid state battery structure including barrier regions. Preferably, the cathode material is configured to provide improved power density for electrochemical cells. The present cathode material can be made using conventional process technology techniques. Of course, there can be other variations, modifications, and alternatives.

The present disclosure achieves these benefits and others in the context of known process technology. However, a further understanding of the nature and advantages of the present disclosure may be realized by reference to the latter portions of the specification and attached drawings.

### BRIEF DESCRIPTION OF THE DRAWINGS

The following diagrams are merely examples, which should not unduly limit the scope of the claims herein. One of ordinary skill in the art would recognize many other variations, modifications, and alternatives. It is also understood that the examples and embodiments described herein are for illustrative purposes only and that various modifications or changes in light thereof will be suggested to persons skilled in the art and are to be included within the spirit and purview of this process and scope of the appended claims.

FIG. 1 is a simplified illustration of an equivalent circuit models setup with an arbitrary number of representative parallel resistors and capacitors according to an example of the present disclosure.

FIG. 2 is a simplified illustration of an equivalent circuit models setup for representing multiple cell stacks or cells connected in parallel according to an example of the present disclosure.

FIG. 3 is a simplified illustration of an equivalent circuit models setup for representing multiple cells connected in series according to an example of the present disclosure.

FIG. 4 is a simplified illustration of an equivalent circuit models setup for representing multiple cells configured in a mixture of parallel and series connections according to an example of the present disclosure.

FIGS. 5A and 5B are schematic representations of function graded materials according to an example of the present disclosure.

FIG. 6A is a schematic drawing of a battery cell provided according to an example of the present disclosure.

FIGS. 6B and 6C are microscope images of lithium diffused into glass substrate, leaving holes in anode.

FIGS. 7A-7E include a list of images of Pinholes formed in evaporation deposited metal film according to an example of the present disclosure.

FIGS. 8A and 8B are illustrations of anode corrosion according to an example of the present invention.

FIGS. 9A-9C illustrate a lithium anode plating schematic according to an example of the present invention.

FIGS. 10A and 10B illustrate a lithium anode plating micro-photograph according to an example of the present invention.

FIGS. 11A and 11B illustrate stress and peeling according to an example of the present invention.

FIG. 12 is a simplified illustration of contour plot showing the discharge volumetric energy density (in Wh/l) of a cell design when discharged at C/10 with different low and high cut-off voltages according to an example of the present disclosure.

FIG. 13 is a simplified illustration of contour plot showing the operational time (in min) of a cell designed for high power applications with different low and high cut-off voltages according to an example of the present disclosure.

FIG. 14 is a simplified illustration of contour plot showing the operational time (in min) of a cell, with improved material properties by adjusting processing conditions, designed for high power applications with different low and high cut-off voltages according to an example of the present disclosure.

FIG. 15 is a simplified illustration of contour plot showing the discharge volumetric energy density (in Wh/l) of a cell designed for wearable device applications with different low and high cut-off voltages according to an example of the present disclosure.

FIG. 16 is a simplified illustration of contour plot showing the discharge volumetric energy density (in Wh/l) of a cell, with improved material properties by adjusting processing conditions, designed for wearable device applications with different low and high cut-off voltages according to an example of the present disclosure.

FIG. 17A is an illustration test procedure according to an example of the present disclosure.

FIG. 17B is an illustration of capacity vs capacity ratio of cycle 1 charge capacity over cycle 1 discharge capacity according to an example of the present disclosure.

FIG. 17C is an illustration of capacity vs capacity ratio of cycle 1 charge capacity over cycle 1 discharge capacity according to an example of the present disclosure.

FIG. 18 is an illustration of 1C energy density ratio vs C/10 energy density ratio according to an example of the present disclosure.

FIG. 19 is an illustration of the experimental discharge curve, and simulated curves from multi-physics simulation and equivalent circuit model according to an example of the present disclosure.

FIG. 20 is a schematic illustration of multiple stack solid-state batteries by winding according to an example of the present disclosure.

FIG. 21 is a schematic illustration of procedure to fabricate multiple stack solid-state batteries by cutting after winding according to an example of the present disclosure.

FIG. 22 is a schematic illustration of multiple stack solid-state batteries by z-folding according to an example of the present disclosure.

FIG. 23 is a schematic illustration of procedure to fabricate multiple stack solid-state batteries by cutting after z-folding according to an example of the present disclosure.

FIG. 24 is a schematic illustration of procedure to fabricate multiple stack solid-state batteries by cutting and stacking according to an example of the present disclosure.

FIG. 25 is a schematic illustration of stacked solid state batteries by consecutive deposition processes according to an example of the present disclosure.

FIG. 26 is a block diagram for solid state battery powered vacuum cleaner according to an example of the present disclosure.

FIG. 27 is a block diagram for solid state battery powered robotic appliance according to an example of the present disclosure.

FIG. 28 is a block diagram for solid state battery powered electric scooter according to an example of the present disclosure.

FIG. 29 is a block diagram for solid state battery powered aero drone according to an example of the present disclosure.

FIG. 30 is a block diagram for solid state battery powered garden tool according to an example of the present disclosure.

FIG. 31 is a block diagram for solid state battery powered ride on garden tractor according to an example of the present disclosure.

FIG. 32 is a block diagram for solid state battery powered hair dryer according to an example of the present disclosure.

FIG. 33 is a block diagram for solid state battery powered smartphone according to an example of the present disclosure.

FIG. 34 is a block diagram for solid state battery powered laptop/tablet according to an example of the present disclosure.

FIG. 35 is a block diagram for solid state battery powered motor vehicle according to an example of the present disclosure.

FIG. 36 is a simplified cross-sectional view of an illustration of an amorphous cathode material according to an embodiment of the present invention.

### DETAILED DESCRIPTION OF THE INVENTION

Solid state batteries have been proven to have several advantages over conventional batteries using liquid electrolyte in lab settings. Safety is the foremost one. Solid state battery is intrinsically more stable than liquid electrolyte cells since it does not contain a liquid that causes undesirable reaction, resulting thermal runaway, and an explosion in the worst case. Solid state battery can store over 30% more energy for the same volume or over 50% more for the same mass than conventional batteries. Good cycle performance, more than 10,000 cycles, and a good high temperature stability also has been reported.

In the context of batteries, it is desired in some applications to be able to limit certain depth-of-discharge (DOD) ranges and depth-of-charge (DOC) ranges that are descriptive of the present battery condition, but that may not be directly measured. In the context of the battery systems, particularly those that need to operate for long period of time and cycles, as aggressively as possible without harming the battery life, for example, in hybrid electric vehicle batteries, laptop computer batteries, portable tool batteries, and the like, it is desired that information regarding state of charge is accurate and fast so one can further control the power/energy output of the batteries, determine if it is necessary to charge the batteries, and determine the health of batteries.

As an example, the use of estimation of parameters for a battery cell has been described in (Zhang et al. U.S. Pat. No. 8,190,384 B2), and assigned to Sakti3, Inc. of Ann Arbor, Mich., which is hereby incorporated by reference in its entirety. This state-of-charge range controlled approach enhances the cycle-ability of the solid-state battery without sacrificing the energy density of the cells/batteries. Although highly successful, the approach can still be improved. Further details of the present disclosure can be found throughout the present specification and more particularly below.

I. Battery Cells can be Represented with Arbitrary Precision Using an Equivalent Circuit Model (“ECM”) (e.g., EC-n, EC-n,m)

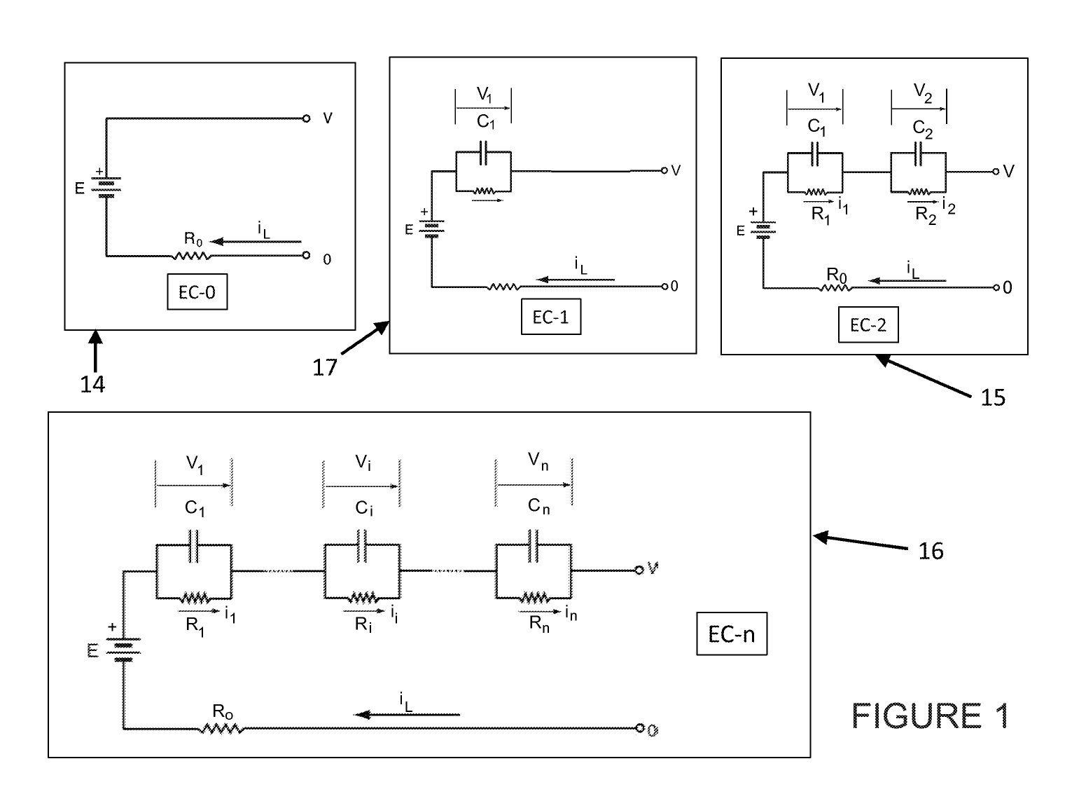

FIG. 1 illustrates an equivalent circuit battery cell model setup with an arbitrary number of representative parallel resistors and capacitors. The equivalent circuit models comprises of at least an ideal DC power source, internal resistance, and an arbitrary number of representative parallel resistors and capacitors, wherein the arbitrary number includes any positive integer and zero and/or a combination of such devices in serial configuration. As an example, EC-0 as 14 in FIG. 1 means the circuit model comprising of a DC power source E, internal resistance Rₒ, and zero of representative parallel resistors and capacitors. As another example, EC-2 as 15 in FIG. 1 means the circuit model comprising of a DC power source E, internal resistance Rₒ, and two of representative parallel resistors and capacitors including couples of C₁ and R₁, and C₂ and R₂. Alternatively, EC-n as 16 in FIG. 1 means the circuit model comprising of a DC power source E, internal resistance Rₒ, and n of representative parallel resistors and capacitors including n couples of C₁ and R₁, C₂ and R₂, and so on until Cₙ and Rₙ. For equivalent circuit model EC-n, output voltage:

$$V = E ( soc ) - {i}_{L} {R}_{0} - {\sum }_{i = 1}^{n} {i}_{i} {R}_{i}$$

where E is the open circuit voltage of the battery cell, soc is the state of charge of the battery cell, i_{L} is the load current applied associated with the application of the battery cell, iᵢ is the current through the resistor Rᵢ. iᵢ is calculated by:

$${i}_{i} ( t ) = {{\int }_{0}}^{t} {e}^{- \frac{1}{{τ}_{i}} ( t - s )} \frac{1}{{τ}_{i}} {i}_{L} ( s ) d s$$

as a solution of the differential equation formulated through current balance:

$${i}_{L} ( t ) = {i}_{i} ( t ) + {C}_{i} \frac{d}{d t} [ {i}_{i} ( t ) {R}_{i} ]$$

where τᵢ=RᵢCᵢ and t is time.

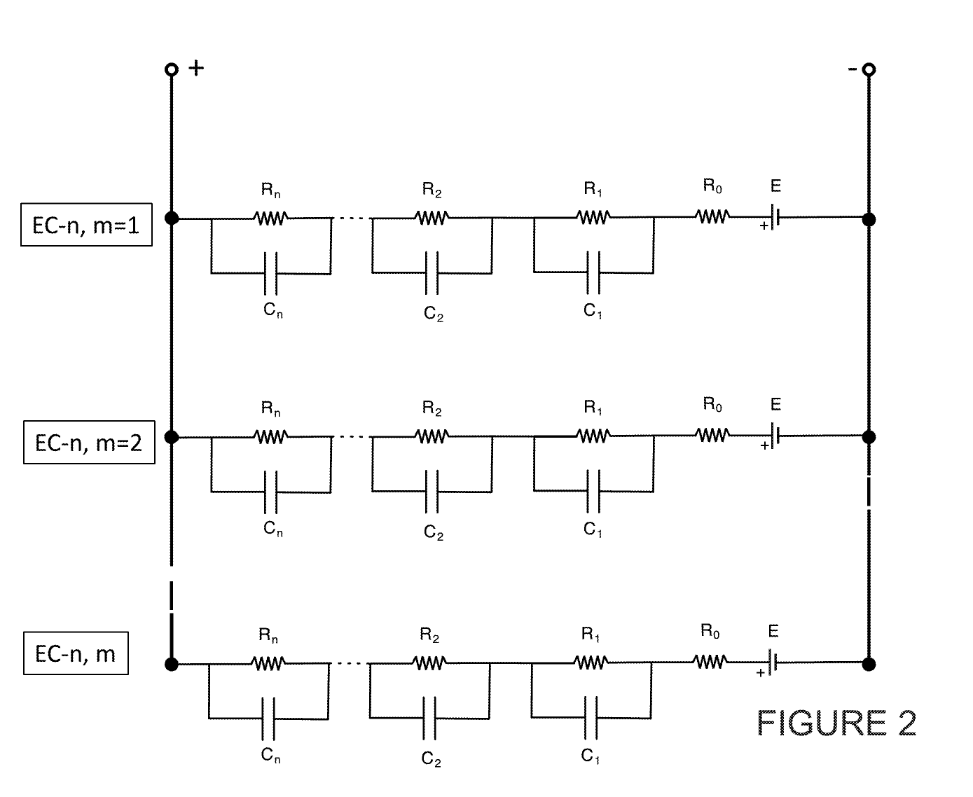

For a solid state battery cell made of multiple cell stacks connected in parallel, each cell stack can be represented by a ECM model, which is shown as EC-n,1 in FIG. 2. For the solid state battery cell made of m cell stacks, it can be represented with m EC-n units, numbered from EC-n,1, EC-n,2, to EC-n,m, as shown in FIG. 2.

For a solid state battery pack made of multiple cells connected in parallel, each cell can be represented by a ECM model, which is shown as EC-n,m in FIG. 2. For the solid state battery pack made of m cells, it can be represented with m EC-n units, numbered from EC-n,1, EC-n,2, to EC-n,m, as shown in FIG. 2.

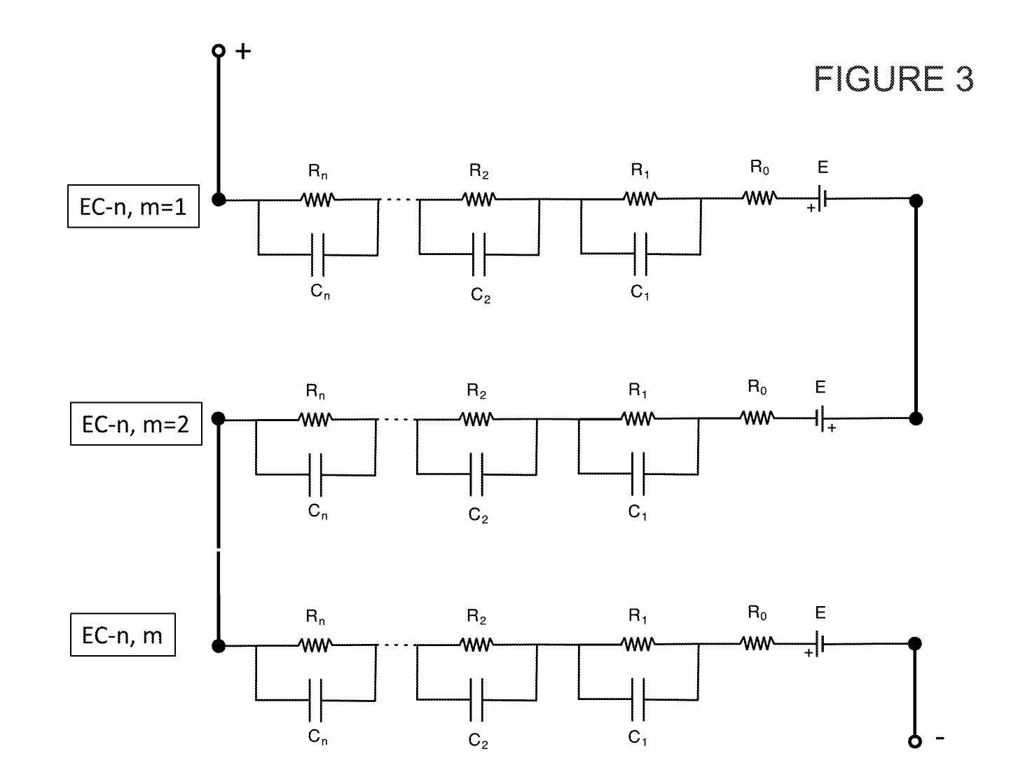

For a solid state battery pack made of multiple cells connected in series, each cell can be represented by a ECM model, which is shown as EC-n,m in FIG. 3. For the solid state battery pack made of m cells, it can be represented with m EC-n units, numbered from EC-n,1, EC-n,2, to EC-n,m, as shown in FIG. 3.

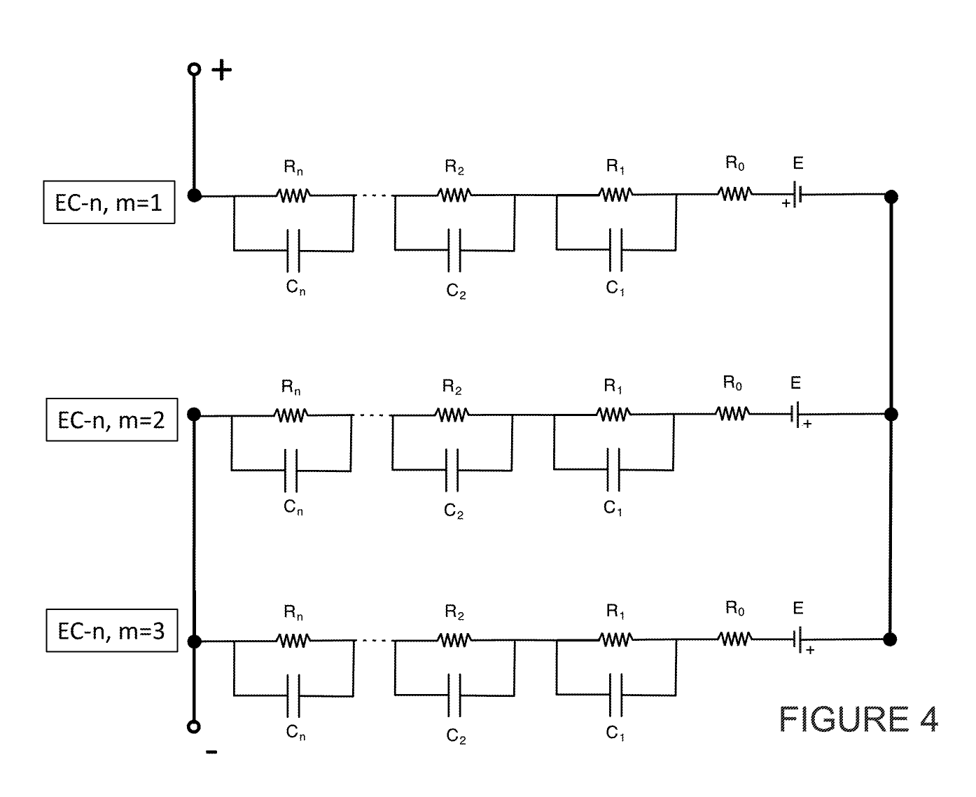

For a solid state battery pack made of multiple cells configured in a mixture of series and parallel connection, each cell can be represented by an ECM model, which is shown as EC-n,m in FIG. 4. In this specific example as shown in FIG. 4, EC-n,2 and EC-n,3 are connected in parallel first, and this group of two cells are then connected in series with EC-n,1. In another embodiment, a plurality of battery groups are connected in series, and each group has a plurality cells connected in parallel, wherein each cell is represented by a EC-n model.

### II. Unexpected Benefits in Controlling SOC, Physical Insights

II.1 Capacity Retention and Functionally Graded Materials

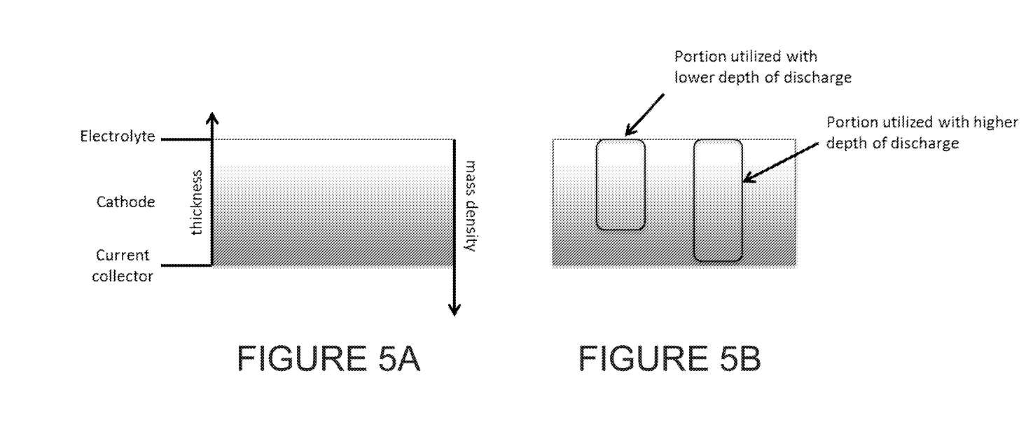

In an example, the present disclosure describes the unexpected benefits of controlling state of charge in solid state battery cathodes with functionally graded properties. Functionally graded materials (FGM) can be characterized by the variation in composition and structure gradually over volume, resulting in corresponding changes in the properties of the material. As an example in FIGS. 5A and 5B, a cathode is made such that mass density decreases as deposition progresses (FIG. 5A) by controlling the process pressure during deposition. In such a battery, less dense material on the top of cathode close to an electrolyte has higher lithium ion diffusivity, thus works better for high power application. Lower diffusivity at a region close to current collectors prevents lithium diffusion through the cathode down to the current collectors. This functionally graded cathode material (FIG. 5B) containing high diffusivity region near the electrolyte and low diffusivity region at the bottom adjacent to the current collector provides unique combination for both high power performance and capacity retention. In an example, the lower diffusivity region has a diffusivity ranging from 1×10⁻¹⁹ m²/s to 1×10⁻⁵ m²/s and the higher diffusivity has a diffusivity value ranging from 1×10⁻¹⁷ m²/s to 1×10⁻⁵ m²/s. In an example functionally graded properties can also include electrical conductivity σ(x,y,z), dielectric constant ∈(x,y,z), mass density ρ(x,y,z), modulus E(x,y,z), thermal conductivity κ(x,y,z), thermal expansion coefficient α(x,y,z), thermal specific heat Cₚ(x,y,z), concentration expansion α_{c}(x,y,z), reaction constant κ₀(x,y,z), and electropotential E(x,y,z). In an example, FGM cathode diffusivity only varies in one dimension (z-direction) and is constant in x- and y-directions. In another example, cathode diffusivity varies in the x-z, y-z, and x-y planes. The present disclosure provides a method of utilizing these advantages of cathode and solid state batteries by defining and controlling the voltage range and the depth of discharge.

Lithium Escaping into Substrate (Specific Embodiment, Glass)

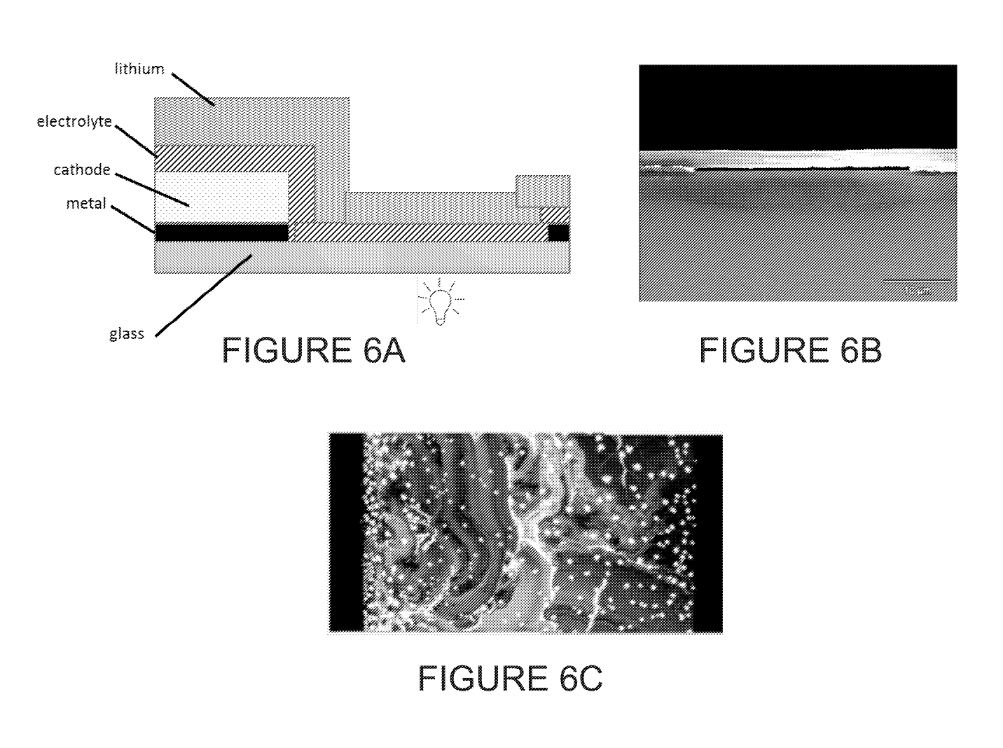

In a specific embodiment, the present disclosure provides a method of preventing loss of lithium ions into a non-active layers in a solid-state battery. In solid state batteries, lithium ions can diffuse through cathode, current collector, and reach a substrate because the thickness of current collector is in the order of microns or less unlike particulate based batteries where a cathode is coated and pressed on a thick metal foil of about 100 μm or thicker. When lithium ions reach a substrate, the ions may diffuse into the bulk of glass substrate, or react with polymer materials, making irreversible reactions. FIG. 6A is a schematic drawing of a battery cell provided according to an example of the present disclosure. In solid state batteries developed at research labs, noble materials such as gold or platinum is used as a barrier layer between the substrate and current collectors, but the use of these materials are not practical in batteries due to prohibitive high price of the materials. FIG. 6C shows a region between two current collectors in a solid state battery with a light source illuminated from the back of the substrate, revealing numerous pinholes formed within lithium layers. FIG. 6B is a cross section SEM image of the same region, identifying the pinholes that are formed by losing lithium into the glass substrate. The present disclosure limits regions where lithium can reach within a cathode to the vicinity of electrolyte away from the current collector, essentially preventing loss of lithium in a substrate. Lower diffusivity at a region close to current collectors prevents lithium diffusion through the cathode down to the current collectors. This functionally graded cathode material containing high diffusivity region near the electrolyte and low diffusivity region at the bottom adjacent to the current collector provides unique combination for both high power performance and capacity retention. That is, the lithium moves within specific spatial regions of the cathode, and is confined within such spatial regions, while staying away from regions, which can lead to diffusion into the bulk substrate or other regions. As one example, 95% of lithium ion will be confined within 95% of cathode thickness from the electrolyte-cathode interface toward the cathode current collector. Of course, there can be other variations, modifications, and alternatives.

Pinholes in Current Collectors

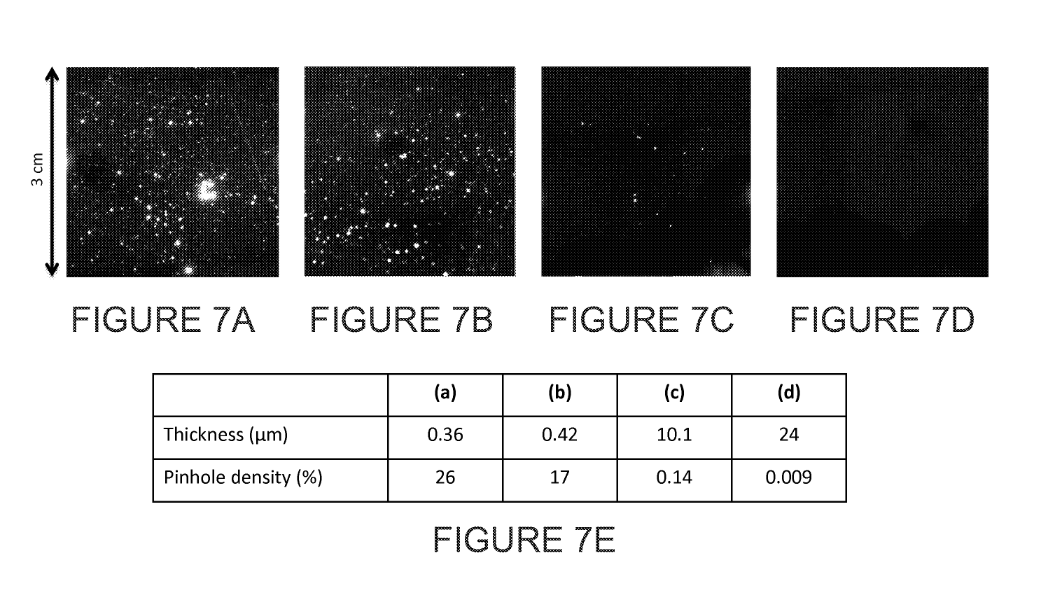

In a specific embodiment, the present disclosure provides a method of preventing lithium diffusion through the pinholes in the current collector, which leads to the initial energy loss and capacity fade in solid state batteries. The method provides regulated cycling range, specifically limiting the state of charge that determines the number of lithium element per the stoichiometric cathode. The cells are operable at a state of charge between a lower bound to an upper bound. As an example, the state of charge lower bound ranges from 0.5% to 75%, and the state of charge upper bound range from 25% to 99.5%. Upon discharging, the lithium species moves into the cathode and start making contact of the current collector. The current collector below a certain thickness, for example 25 microns for aluminum film, made by high rate evaporation may contain a number of pinholes as shown in FIGS. 7A-7E, and the lithium ions reaching the current collector and its pinholes may diffuse into the substrate and be lost to irreversible reaction.

The present disclosure limits regions where lithium can reach within a cathode to the vicinity of electrolyte away from the current collector, essentially preventing loss of lithium in a substrate. Lower diffusivity at a region close to current collectors prevents lithium diffusion through the cathode down to the current collectors. This functionally graded cathode material containing high diffusivity region near the electrolyte and low diffusivity region at the bottom adjacent to the current collector provides unique combination for both high power performance and capacity retention. That is, the lithium moves within specific spatial regions of the cathode, and is confined within such spatial regions, while staying away from regions, which can lead to diffusion into the bulk substrate or other regions. As one example, 95% of lithium ion will be confined within 95% of cathode thickness from the electrolyte-cathode interface toward the cathode current collector.

Anode Corrosion

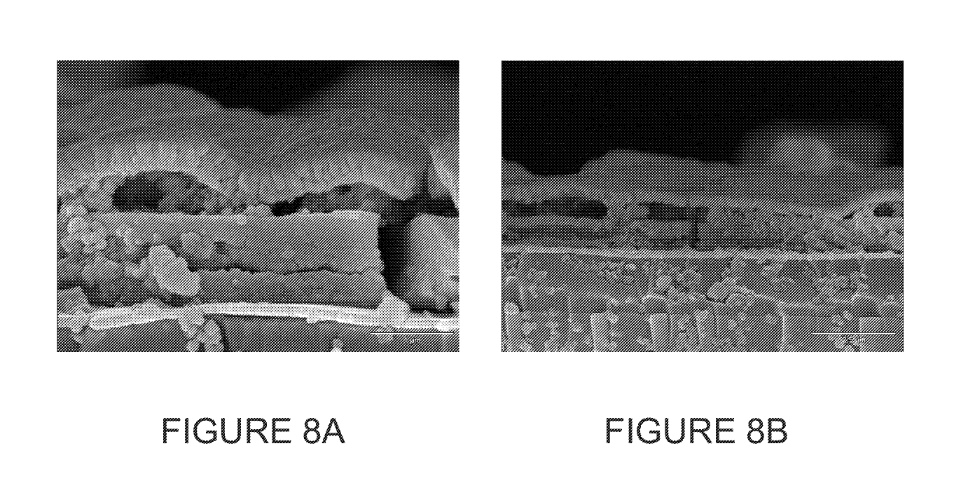

In a specific embodiment, the present disclosure provides a method for preventing a solid-state battery device from lithium corrosion within the anode layer. The method includes regulating the depth-of-discharge, specifically the lower limit of cycling voltage, and preventing fully discharging of the solid-state batteries. Upon discharging, a portion of lithium anode layer intercalates into the cathode through the electrolyte, leaving some portion of lithium layer in the original region to maintain the conduction and diffusion path for the following cycles. If a solid state battery is fully or even overly discharged, which drives the significant portion of lithium within the anode into the cathode, the remaining lithium within the anode may become very thin and susceptible to corrosive chemical species of lithium such as oxygen, nitrogen, and water. The formations of lithium oxides, nitrides, and lithium hydroxides are irreversible and the lithium consumed in these reactions is not retrievable for further cycles (FIGS. 8A and 8B). Thus, the invention provides a method of retaining the initial or specified capacities of solid-state batteries by preventing the loss of active lithium within the device.

The mechanism for preserving reactive lithium is the protection of lithium from corrosion by limitation of overdischarge. We determined that overdischarge results in lithium diffusion into the cathode current collector and into substrates for other inert layers. We further found that overcharge results in lithium diffusion into barrier or other layers designed to entrain lithium into the spatial region of the anode. As an example, such layers have been described in (Kim et al. U.S. Pat. App. No. 20120040233), and assigned to Sakti3, Inc. of Ann Arbor, Mich., which is hereby incorporated by reference in its entirety.

Lithium Anode Plating

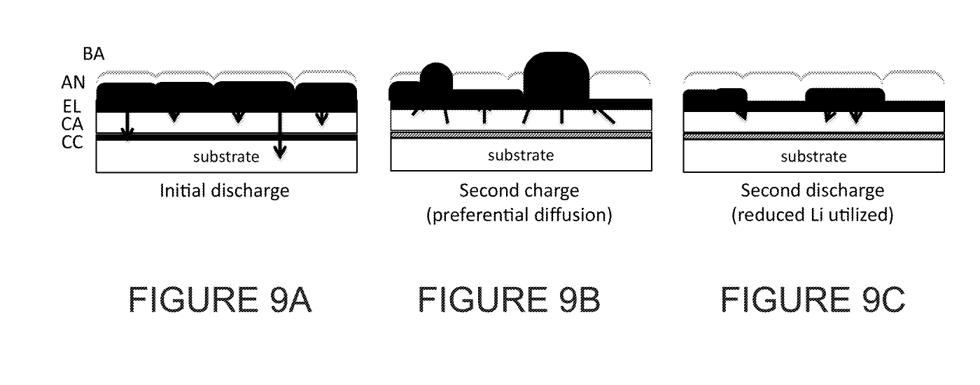

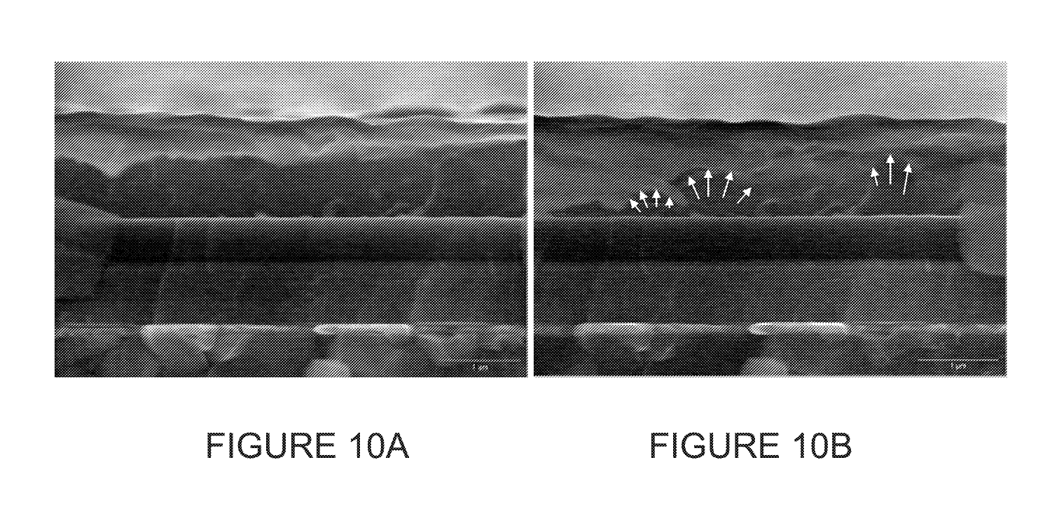

In a specific embodiment, the present disclosure provides a prevention technique against the preferential lithium plating and the resulting energy loss of a solid-state battery device. Preferential lithium plating is referring to the non-uniform lithium diffusion across the electrolyte and anode interface, or local plating, when charging. This phenomenon leads to capacity drops in the following discharge cycles due to the loss of accessible lithium in some area within the anode layer as shown in the FIGS. 9A-9C and FIGS. 10A and 10B. FIGS. 9A-9C illustrate a non-uniform lithium anode plating schematic during recharge. This leads to non-uniform current distribution and excessive localized current distribution. FIGS. 10A and 10B illustrate a lithium anode plating micro-photograph according to an example of the present invention.

Another issue with the lithium plating is the increase of impedance due to the discontinuity across the anode that provides diffusion and conduction path for the lithium ions and electrons. Such discontinuity creates an inhomogeneous distribution of lithium in the anode spatial region, which can result in reduced overall charge density over a homogenously distributed material. In some cases, this inhomogeneity could be sufficient to cause the anode regions to be unpercolated, namely sufficiently dispersed and unconnected such that there is not a domain spanning conductive path in the x-y plane.

Stress and Peeling Layers

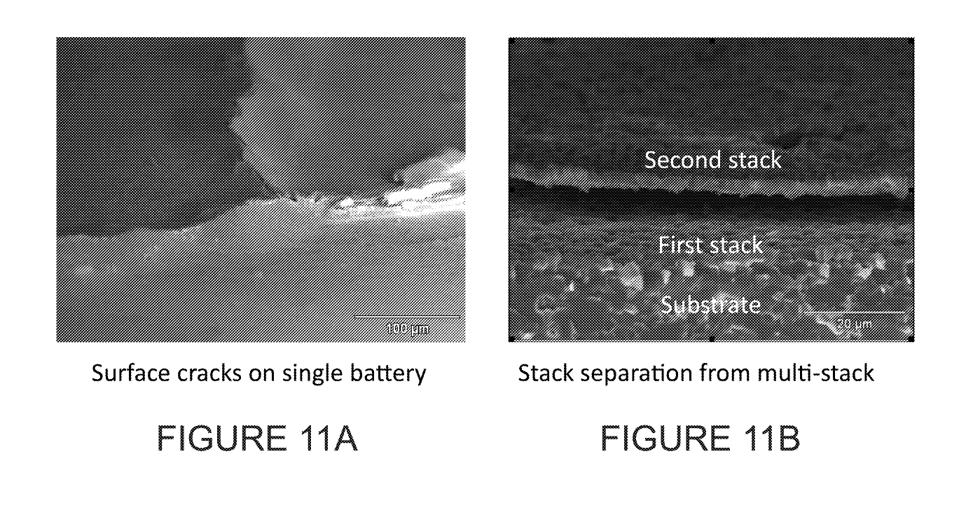

In a specific embodiment, the present disclosure provides a method of restraining the stress within individual films and multilayers. Previously described cycling of solid state batteries causes significant intercalation-induced stresses by transporting lithium species between cathode and anode layers. This may result in film cracking and peeling, especially in combination with lithium corrosion and/or undesired lithium diffusion into the current collector and substrate. Fracture, or crack on the cell layers due to high film stress causes discontinuity, short circuits, and current leakage, which leads to low energy density and short cycle life. Examples of stress-induced film cracks and interlayer fractures are shown in FIGS. 11A and 11B.

The present disclosure provides a method of regulating the state of charge to reduce the intercalation induced strain and stress during cycling, and thus prevent cracking and peeling of battery among solid state battery layers. State of charge regulation governs the state of stress because state of charge determines the state of intercalation stress in the battery cell. In one example, overdischarge would result in no material remaining in the anode spatial region, resulting in a zero stress boundary between the electrolyte and the anode spatial regions. This in turn could result in cracking or other damages to the electrolyte because the presence of the anode layer provides a cohesive force on the electrolyte during the operation of the cell. In another example, overdischarge of the cell could result in formation of one or more lithium rich layers in the cathode spatial region, which results in changed stress on the boundaries of the cathode spatial region. In another example, overdischarge leading to a concentration of anode material in the cathode current collector could alter the stress of the current collector on the surface of the cathode resulting in irreversible cracking or other damage including delamination. Any of these phenomena, for example, damage to an electrode or electrolyte, or loss of electrical contact between any layers would results in reduced energy density of the cell.

Controlling state-of-charge (SOC) while cycling the solid state battery cells has unexpected benefits. These benefits are further explained by the underpinning physical mechanisms explained as follows.

### III. Designed Energy Density by Controlling SOC, Contour Plot

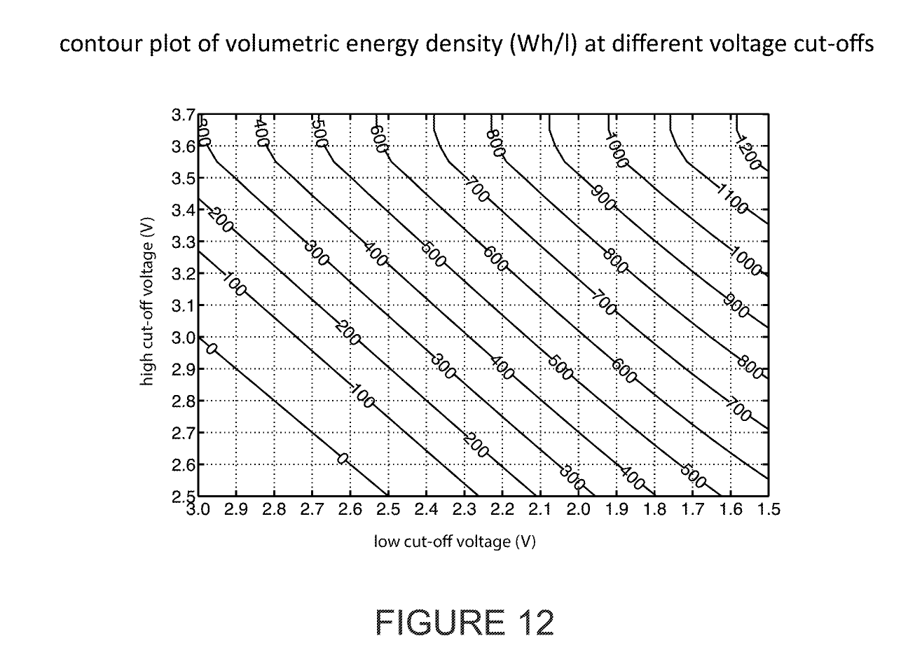

Because solid state batteries have much higher energy densities than conventional batteries, these batteries are capable of delivering very high energy density even cycled at limited SOC (not full SOC range). FIG. 12 shows the discharge volumetric energy density (in Wh/l) of an example cell design when discharged at C/10 at different high and low cut-off voltages. It is shown that there are very wide range of options which can deliver energy densities greater than 700 Wh/l (or 800 Wh/l or 900 Wh/l or 1000 Wh/l).

### IV Designed Operational Time for High Power Applications by Controlling SOC, for High Power

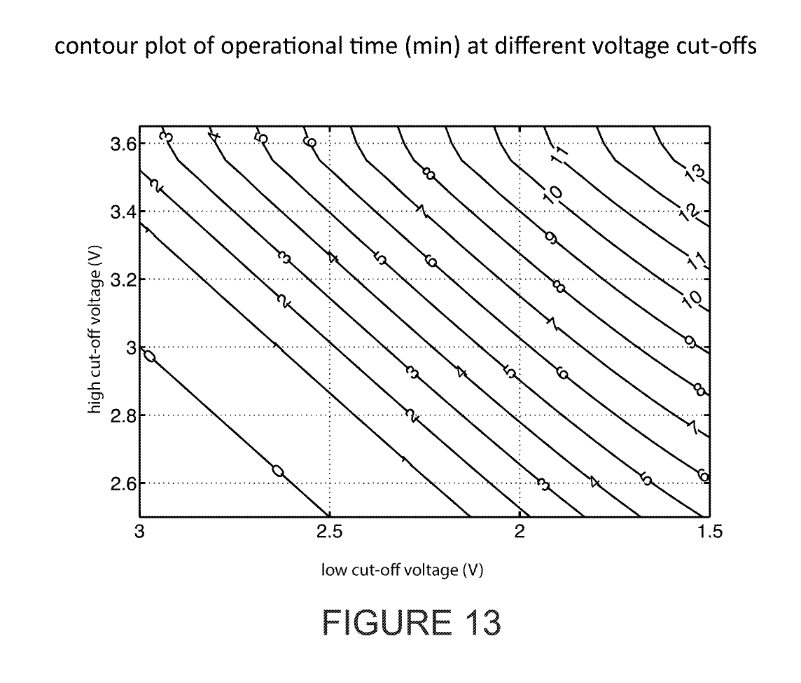

Because solid state batteries have much higher energy densities than conventional batteries, these batteries are capable of delivering very high energy density even cycled at limited SOC (not full SOC range). For a specific high power application using such batteries, the application device can operate longer time using such batteries. FIG. 13 shows the operational time (in minutes) of an example cell design when discharged at a very high power of 25 W at different high and low cut-off voltages.

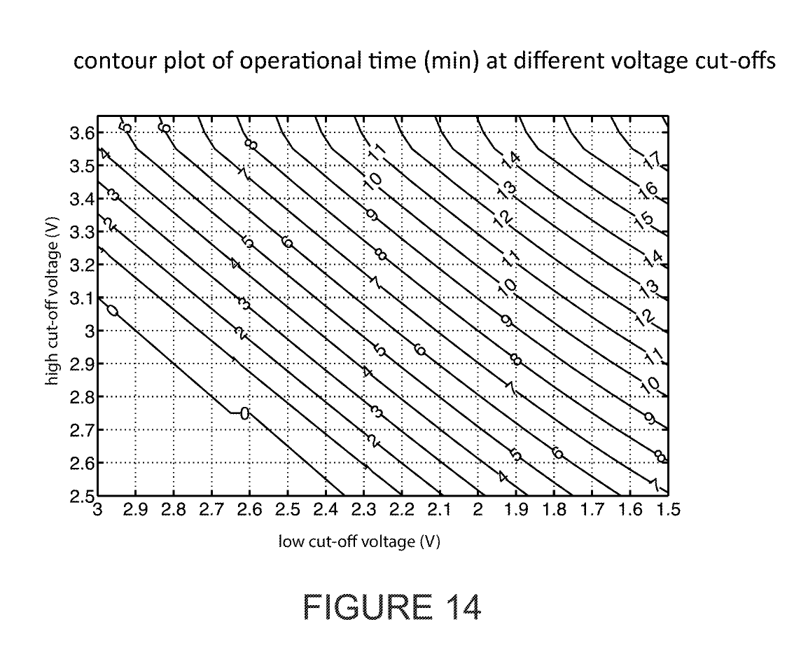

Battery material properties can also be adjusted by tuning processing parameters, such as background gas types, background gas partial pressure, and substrate temperature. As an example, increasing gas pressure will result in decrease in mass density and increase in diffusivity. As another example, by changing the gas type, we can change the concentration of different species in the film composition. FIG. 14 shows the operational time (in minutes) of an example cell design with improved material properties when discharged at a very high power of 25 W at different high and low cut-off voltages. In this cell design, cells are deposited on a thin flexible substrate.

### V. Designed Energy Density for Cells Targeting Wearable Device Applications

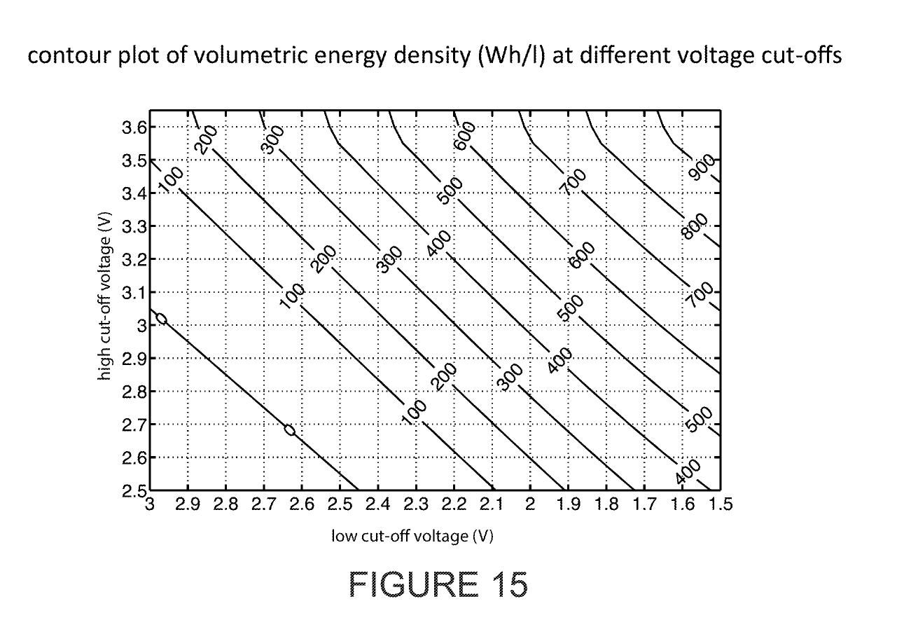

Because solid state batteries have much higher energy densities than conventional batteries, these batteries are capable of delivering very high energy density even cycled at limited SOC (not full SOC range). For a specific wearable device application using such batteries, FIG. 15 shows the deliverable energy density of an example cell design when discharged at 67 mA at different high and low cut-off voltages.

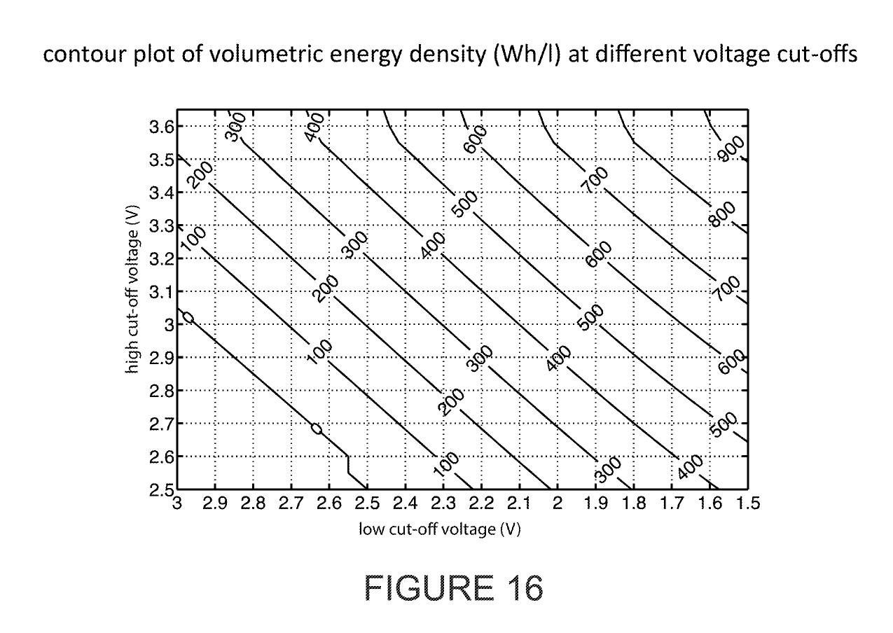

Battery material properties can also be adjusted by tuning processing parameters. FIG. 16 shows the deliverable energy density of an example cell design with improved material properties when discharged at 67 mA at different high and low cut-off voltages. In this cell design, cells are deposited on a thin flexible substrate.

1. Capacity Loss

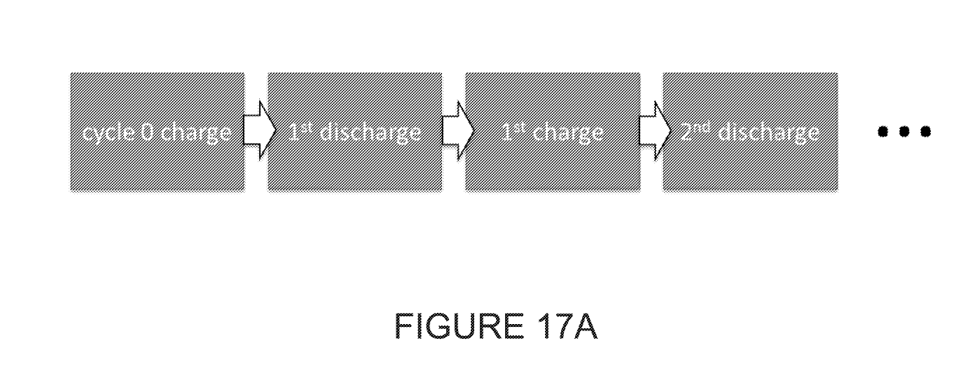

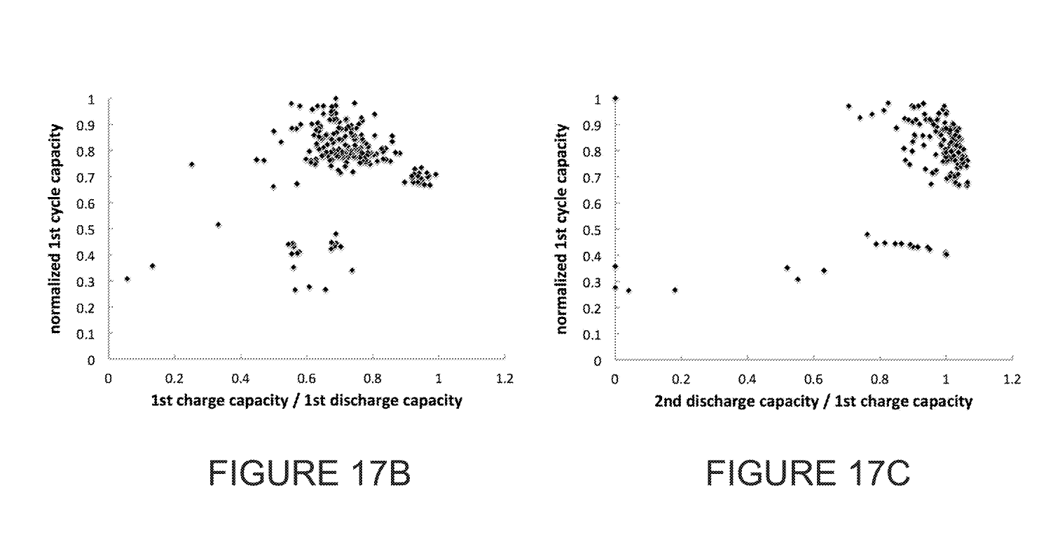

FIG. 17A describes the common test protocol. Cycle 0 charge at C/10 is used to make sure each cell has initial 3.7V. And it is followed by cycle 1 discharge and cycle 1 charge at C/10. The test goes on with incremental cycle number. FIG. 17B illustrates the normalized capacity vs capacity ratio. The capacity value is normalized by simulation capacity using multi-physics simulation with actual cell specifications including cell dimensions and material properties. FIG. 17B illustrates the normalized capacity vs capacity ratio of cycle 1 charge capacity over cycle 1 discharge capacity. FIG. 17C illustrates the normalized capacity vs capacity ratio of cycle 2 discharge capacity over cycle 1 charge capacity. Data group are more disperse in FIG. 17B while more data aggregate at the ratio 1 in FIG. 17C. The result shows the capacity fade most happens in cycle 1 discharge step.

2. Functional Graded Material

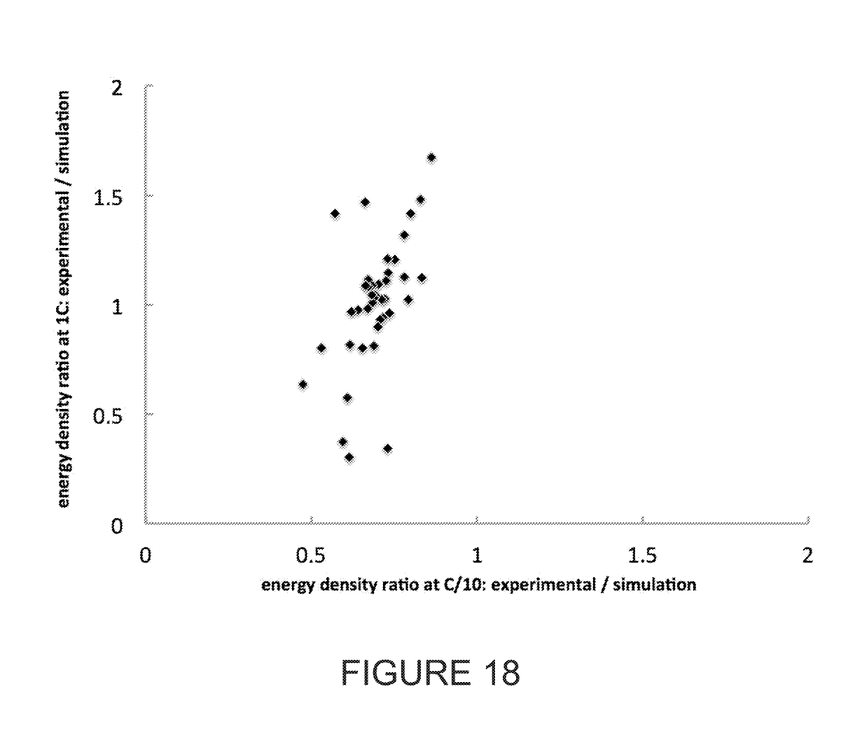

FIG. 18 illustrates the 1C energy density ratio vs C/10 energy density ratio. The ratio is calculated by experimental result normalized by simulation energy density result using multiphysics simulation with actual cell specifications including cell dimensions and material properties. This diagram illustrates that most of the cell performance at 1C outperform the simulation result while most of the cell performance at C/10 is worse than the simulation result. The diagram implies the inhomogeneous material such as functional graded material can be made so that multiphysics simulation with homogenous material properties assumption cannot fit the result at two different discharge rate at the same time.

3. Discharge Curve Comparison

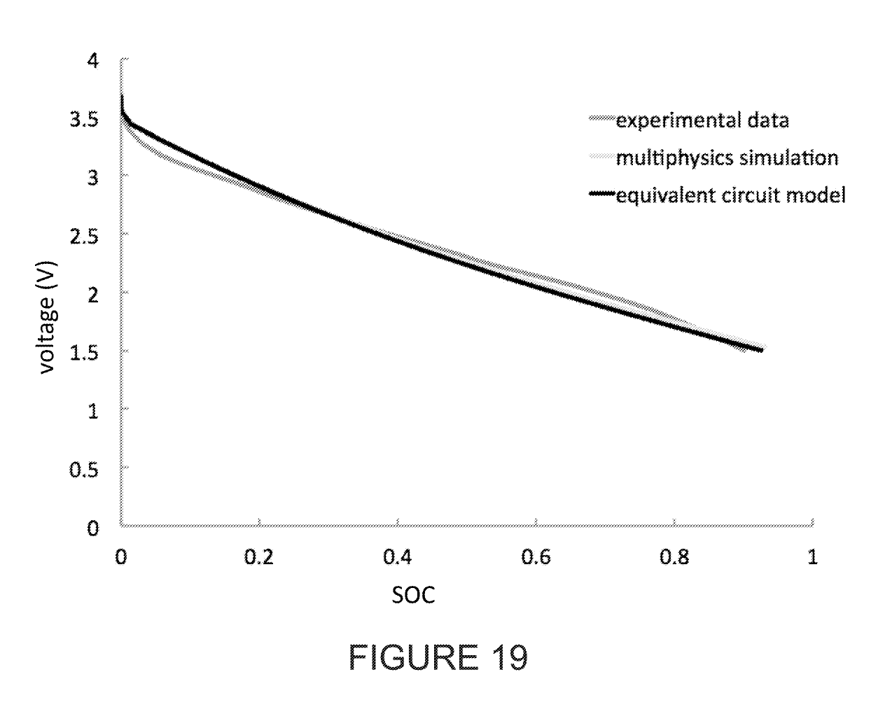

FIG. 19 illustrate the experimental discharge curve, multiphysics simulational discharge, and equivalent circuit model fitting result. Multiphysics simulation is based on 3D finite element simulation. EC-1 model type as 17 in FIG. 1 shown is used for equivalent circuit model. Multiphysics simulation with actual cell specifications including cell dimensions and material properties fits the experimental discharge curve well. Equivalent circuit model with fitting parameters of R1=200Ω R0=100Ω and C1=0.0005 F also demonstrates the fitted discharge curve close to experimental result.

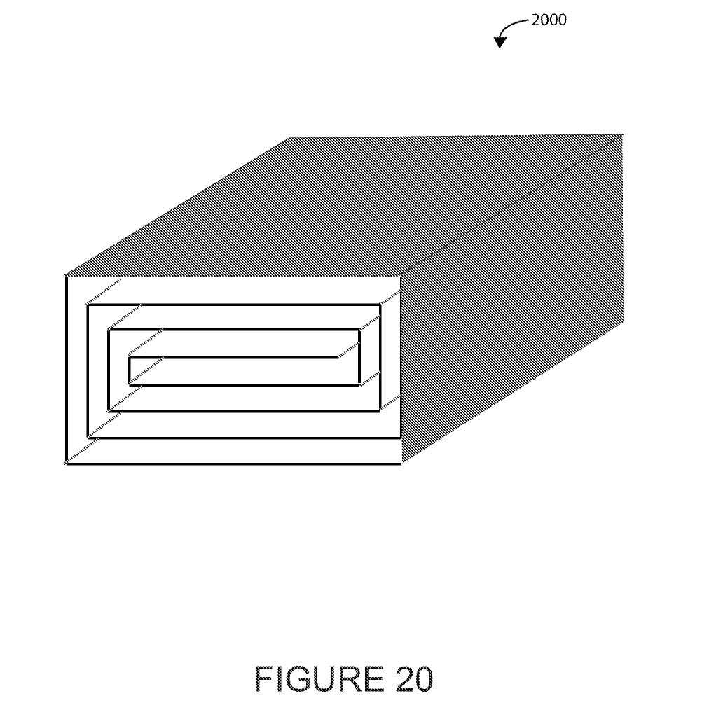

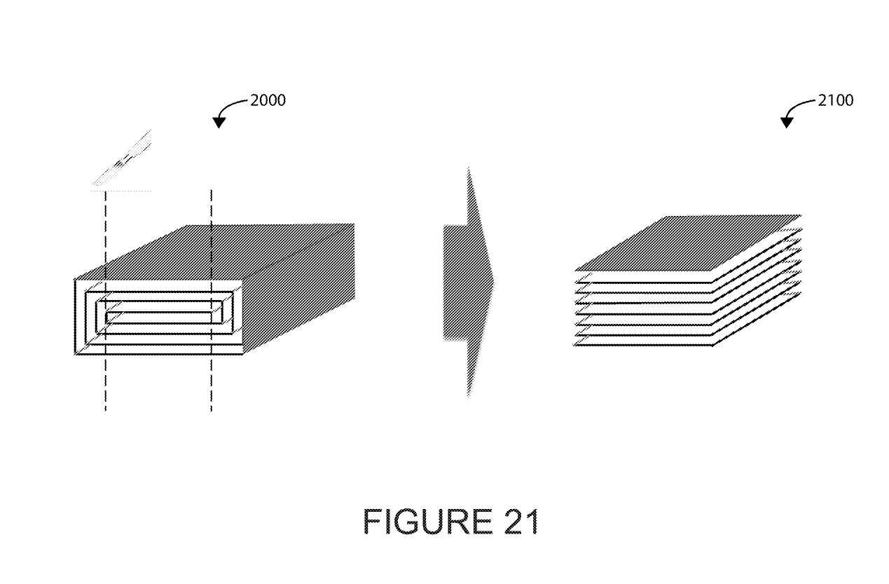

EXAMPLE 1: building multiple stack solid state batteries by winding: As an example, the present invention provides a method of using a flexible material that has a thickness in the range between 0.1 and 100 μm as the substrate for the solid state batteries. The flexible material can be selected from polymer film, such as PET, PEN, or metal foils, such as copper, aluminum. The deposited layers that comprise solid state batteries on the flexible substrate, then can be wound into a cylindrical shape or wound then compressed into a prismatic shape. FIG. 20 shows the image of the wound cell 2000 as an example of the present invention. The wound cells 2000 can further be processed by cutting the round corners (2100) to maximize the energy densities as shown in FIG. 21.

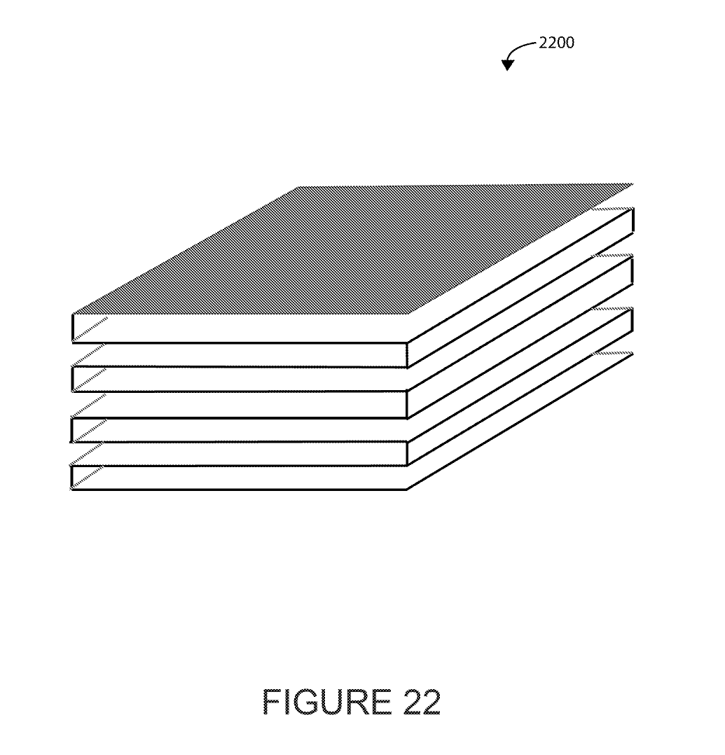

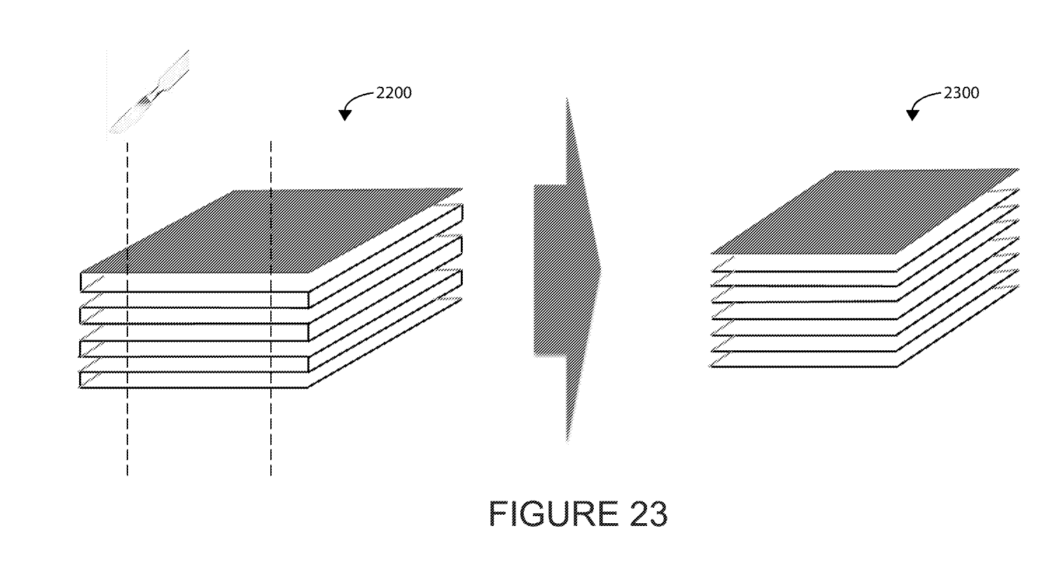

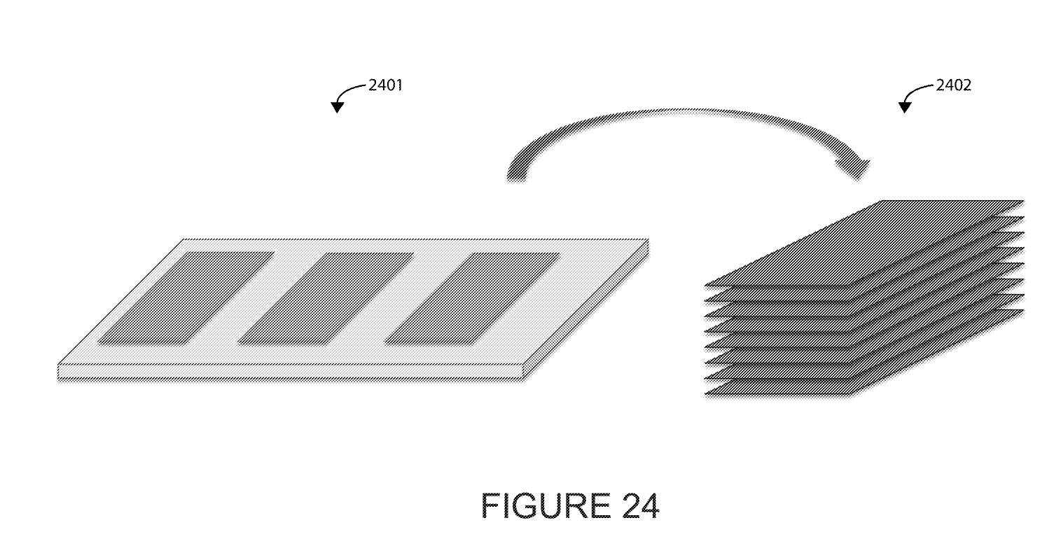

EXAMPLE 2: building multiple stack solid state batteries by z-folding: As an example, the present invention provides a method of using a flexible substrate that can be a part of solid state batteries. As shown in FIG. 22, the deposited layers of solid state batteries on the flexible substrate 2200 can be stacked by z-folding. The z-folded cells 2200 can further be processed by cutting two sides of cells (2300) and terminating them to maximize the energy densities as shown in FIG. 23. By alternating the process sequence, another configuration of multistack battery can be made by cutting the individual layers 2401 and then stacking them (2402) as illustrated in FIG. 24.

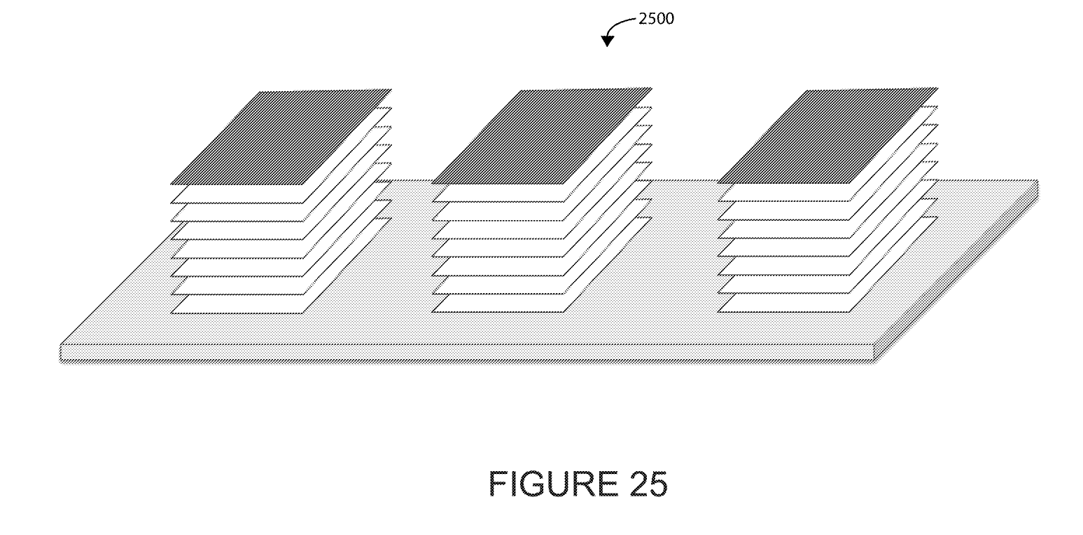

EXAMPLE 3: building multiple stack solid state batteries by iterative deposition process: As an example, the present invention provides a method of building multiple stack solid state batteries by moving a substrate through a number of deposition processes. By repeating a sequence of processes by N times, the solid state battery device 2500 has N number of stacks as shown in the schematic diagram in FIG. 25.

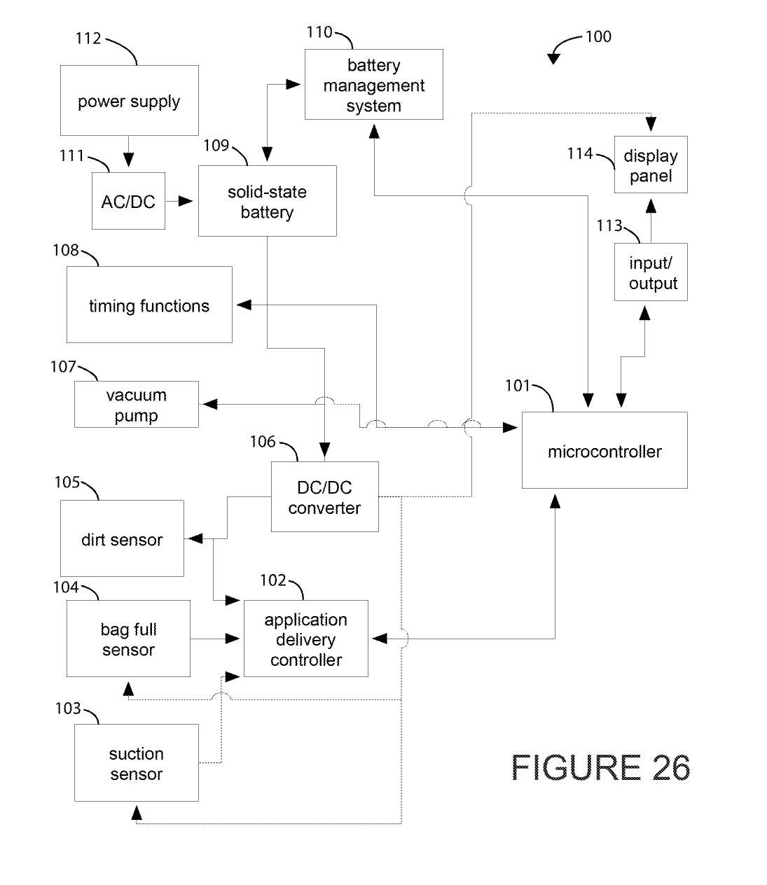

EXAMPLE 4 vacuum cleaner, FIG. 26 shows schematically the control means of the electric vacuum cleaner, 100, and power supply means of such device. Control means in the form of a microcontroller 101 includes appropriate control circuitry and processing functionality through application delivery controller 102 to process signals received from its various sensors, such as the suction sensor 103, dirt sensor 104, and bag full sensor 106, and to pass the information back to the microcontroller 101 to drive the vacuum pump 107 in a suitable manner. The power source of such a device is powered by a solid state battery/pack 109. The specific embodiment of current invention is implemented into the battery management system 110, which is controlling and monitoring the state of charge of the solid state battery/pack to achieve required power during the operation and prolong solid state battery/pack cycle life. External power source can be connected through the power supply unit 112, through the AC/DC converter 111 to recharge the solid state battery/pack.

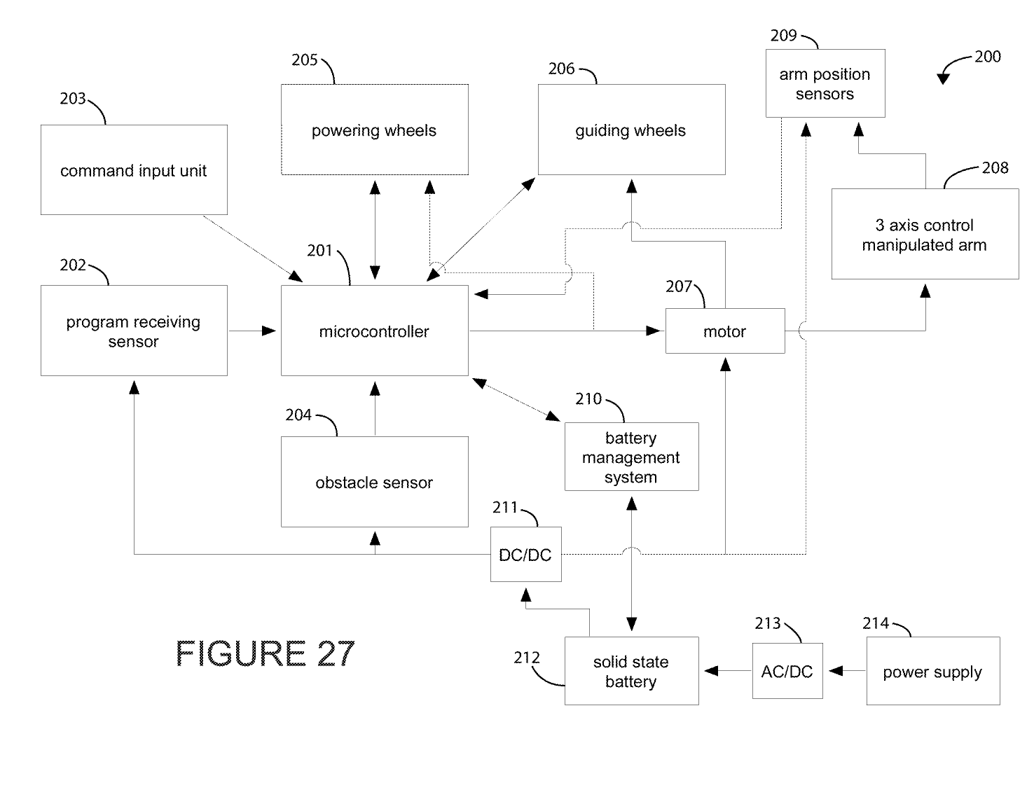

EXAMPLE 5 robotic appliance, FIG. 27 shows schematically the control means of the electric robotic appliance 200, and power supply means of such device. In this example, the three-axis control manipulated arm is used as an illustration how similar appliance using robotic technologies to maneuver around to accomplish specific tasks. Other means of electric power assisted device with robotic technology so that the whole appliance can move accordingly to complete desired tasks. Control means of this robotic appliance in the form of a microcontroller 201 includes appropriate control circuitry and processing functionality through command input unit 203 or from its various sensors, such as the obstacle sensor 204, arm position sensors 209, and program receiving sensor 202, and to pass the information back to the microcontroller 201 to drive the motor 207 in a suitable manner to power the guiding wheels 206, and powering wheel 205, and position the three-axis control manipulated arm 208 to its desired configuration. The power source of such a device is powered by a solid state battery/pack 212. The specific embodiment of current invention is implemented into the battery management system 210, which is controlling and monitoring the state of charge of the solid state battery/pack to achieve required power during the operation and prolong solid state battery/pack cycle life. External power source can be connected through the power supply unit 214, through the AC/DC converter 213 to recharge the solid state battery/pack.

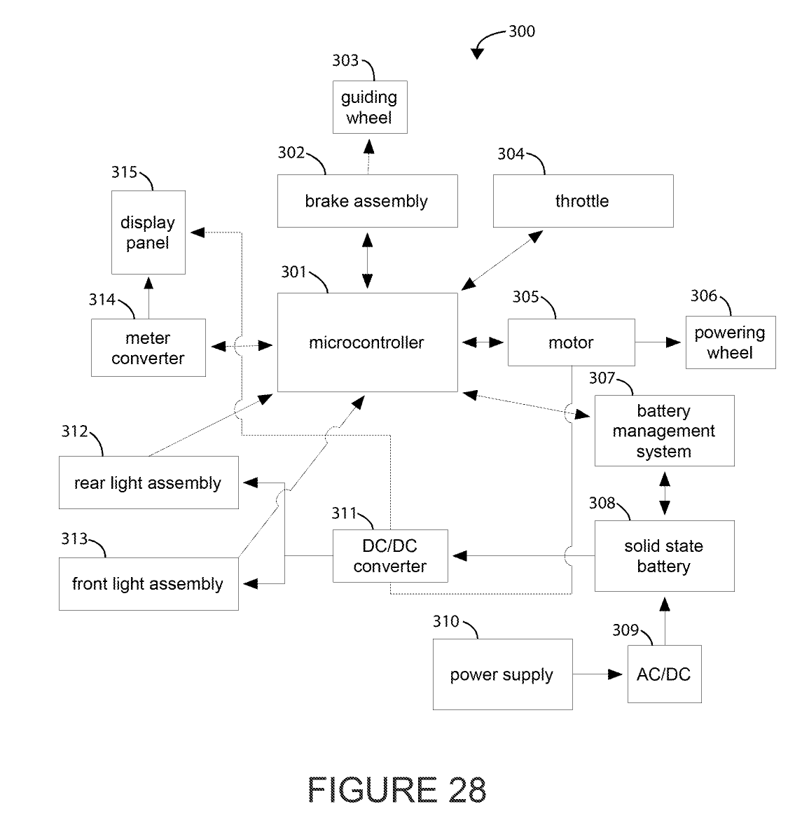

EXAMPLE 6 electric scooter, FIG. 28 shows schematically the control means of the electric scooter 300, and power supply means of such vehicle. Control means in the form of a microcontroller 301 includes appropriate control circuitry and processing functionalities through microcontroller 301 to process signals received from throttle 304, rear light assembly 312, front light assembly 313, and brake assembly 302. In electric scooter, the main feedback control is provided the rider himself therefore, the control algorithm is less sophisticated. The power source for electric scooter is powered by a solid state battery/pack 308. The specific embodiment of current invention is implemented into the battery management system 307, which is controlling and monitoring the state of charge of the solid state battery/pack to achieve required power during the operation and prolong solid state battery/pack cycle life. External power source can be connected through the power supply unit 310, through the AC/DC converter 309 to recharge the solid state battery/pack.

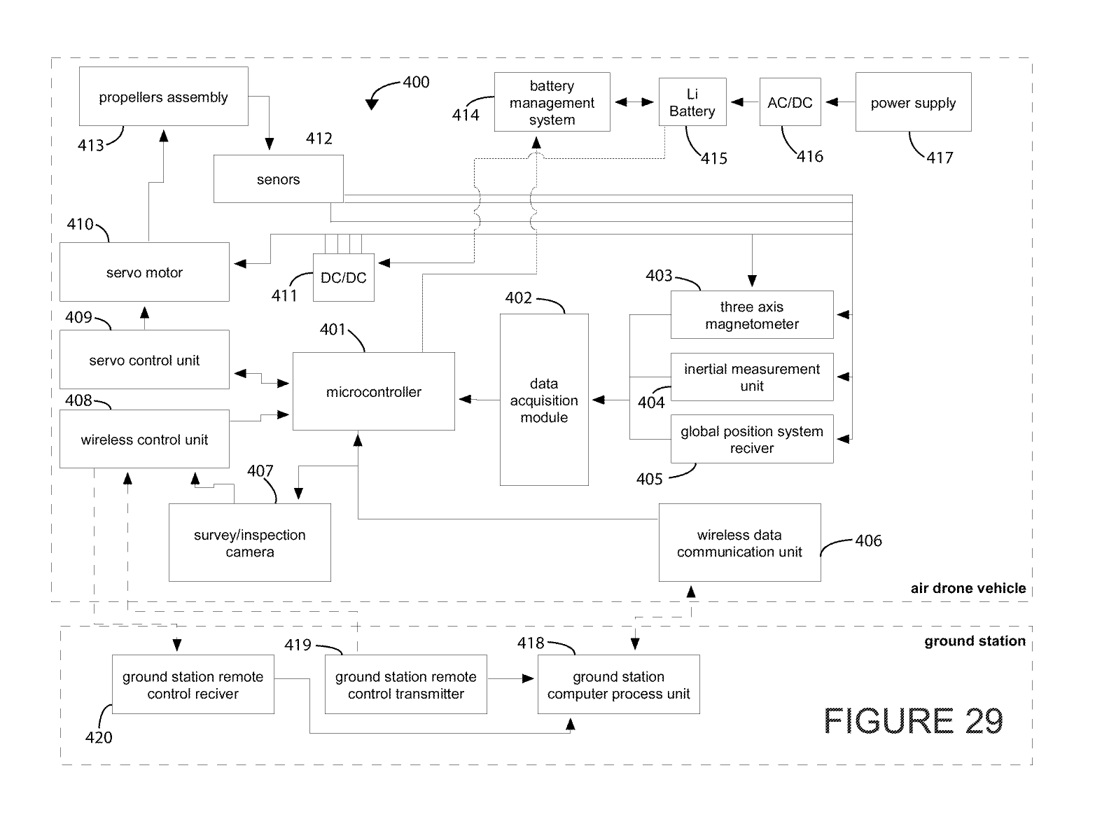

EXAMPLE 7 aero drone, FIG. 29 shows schematically the control means of the electric aero drone 400, and power supply means of such vehicle. Because of this type wireless control feature, these type of device includes two parts: ground station and aero drone itself. Control means for the aero drone in the form of a microcontroller 401 includes appropriate control circuitry, data acquisition module 402 to identify the location of the aero drone and control the fly status of the aero drone using the inertial measurement unit 403, global position system receiver 404 and three axis magnetometer 405, then feed those data to the microcontroller 401 to control servo motor 410 to power the propeller assembly 413. The ground station can control aero drone through remote control transmitter 419, and the aero drone can submit survey picture or data back to the ground station through wireless control unit 408 with ground station remote control receiver 420. Ground station computer unit 418 controls both remote control transmitter and receiver. The power source for aero drone is powered by a solid state battery/pack 415. The specific embodiment of current invention is implemented into the battery management system 414, which is controlling and monitoring the state of charge of the solid state battery/pack to achieve required power during the operation and prolong solid state battery/pack cycle life. External power source can be connected through the power supply unit 417 through the AC/DC converter 416 to recharge the solid state battery/pack.

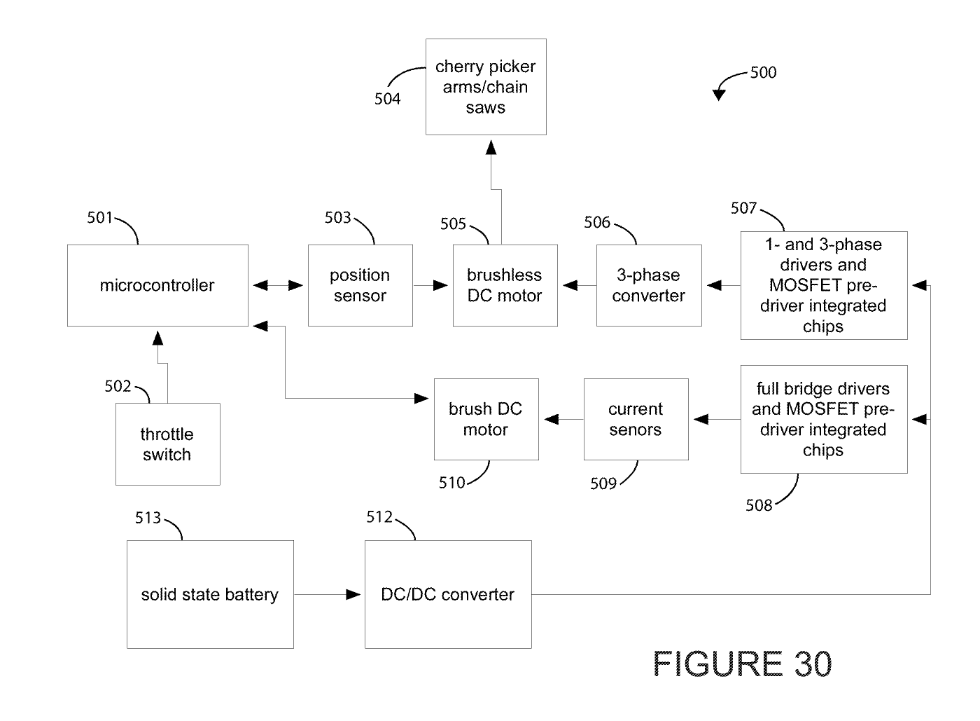

EXAMPLE 8 garden tool, FIG. 30 shows schematically the control means of a electrical garden tool 500, and power supply means of such device. This is as an example of using solid state power portable power tools, but it is not limited to such appliance only. Control means in the form of a microcontroller 501 includes appropriate control circuitry and processing functionalities through position sensor 503 and throttle switch 502. The microcontroller than can control the MOSFET chips and drive the brushless DC motor, and brush motor to power the application unit, such as the cherry picker arms or chain saws 504 as in this example. The power source for electric scooter is powered by a solid state battery/pack 513. The specific embodiment of current invention is implemented into the microcontroller 501, which is controlling and monitoring the state of charge of the solid state battery/pack to achieve required power during the operation and prolong solid state battery/pack cycle life. The DC/DC converter 512 uses to power the motors. The solid state battery can be unplugged from the device to be charged separately.

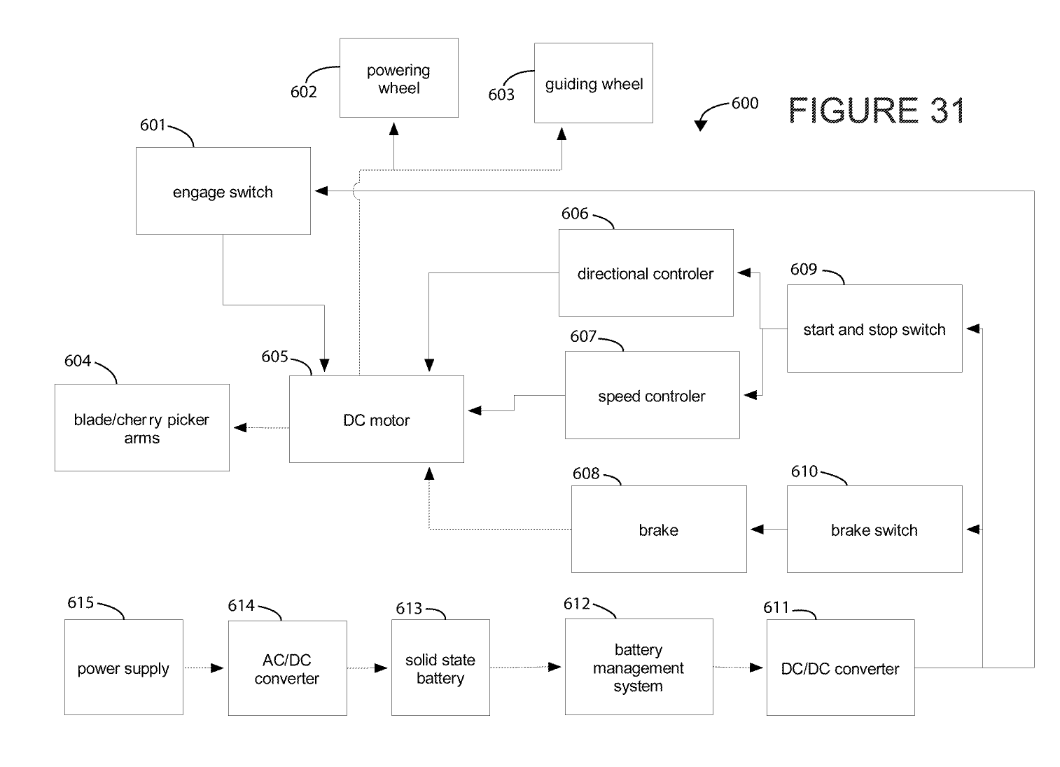

EXAMPLE 9 garden tractor, FIG. 31 shows schematically the control means of a electric ride on garden tractor 600, and power supply means of such vehicle. Control command is provided by the rider. The power source for electric ride on garden tractor is powered by a solid state battery/pack 613. The specific embodiment of current invention is implemented into the battery management system 612, which is controlling and monitoring the state of charge of the solid state battery/pack to achieve required power during the operation and prolong solid state battery/pack cycle life. External power source can be connected through the power supply unit 615, through the AC/DC converter 614 to recharge the solid state battery/pack. The solid state battery will power the start and stop switch 609, brake switch 610, directional controller 606, speed controller 607, DC motor 605 and brake 608 so that they will control power wheel 602 and guiding wheel 603.

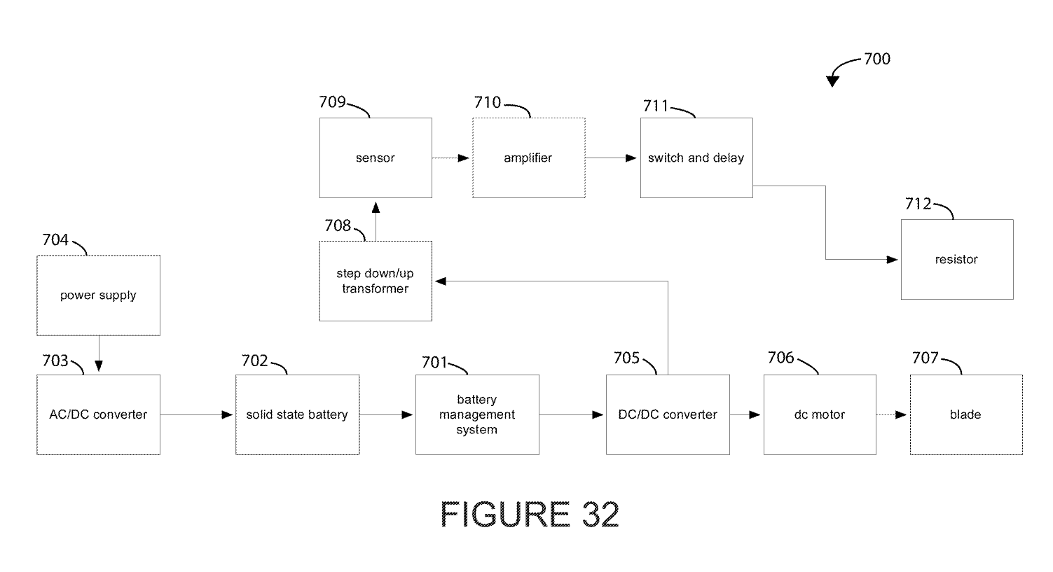

EXAMPLE 10 hair dryer, FIG. 32 shows schematically the control means of the electric hair drier 700, and power supply means of such electrical appliance. This is as an example of using solid state power personal care appliance, but it is not limited to such appliance only. Control means in the form switching on or off Once this electrical appliance is turned on, the solid state battery 702 can powered the resistor 712 as a heater and the DC motor 706 to drive the fan blade 707 to blow the heat from the resistor 712 to the hair. The specific embodiment of current invention is implemented into the battery management system 701, which is controlling and monitoring the state of charge of the solid state battery/pack 702 to achieve required power during the operation and prolong solid state battery/pack cycle life. External power source can be connected through the power supply unit 704, through the AC/DC converter 703 to recharge the solid state battery/pack.

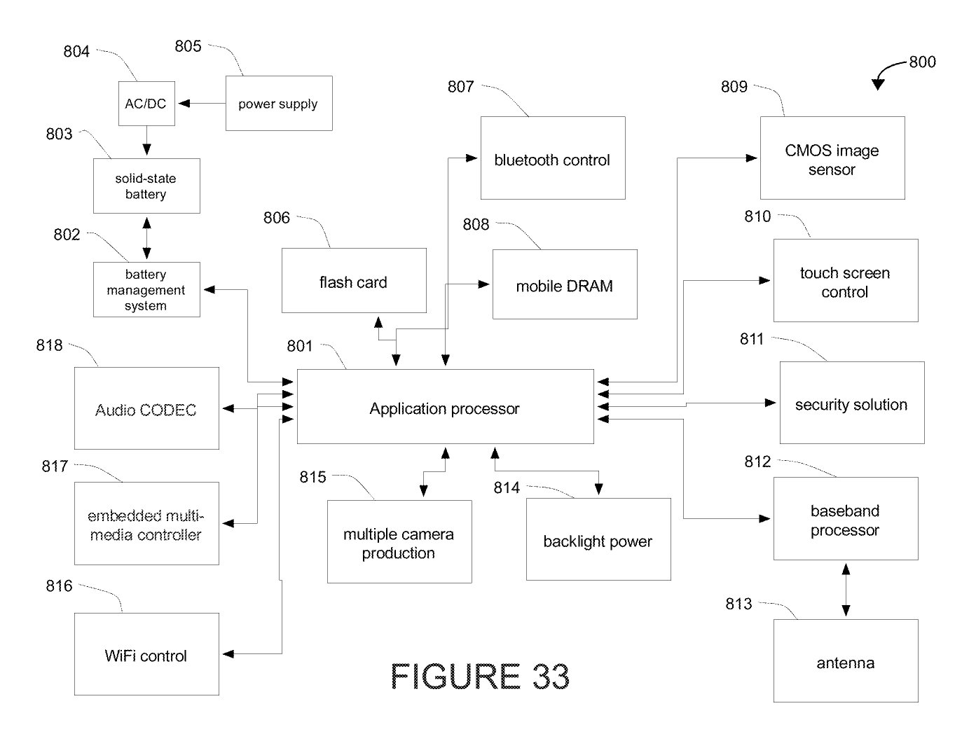

EXAMPLE 11 smartphone, FIG. 33 shows schematically the control means of the smartphone 800, and power supply means of such electrical appliance. This is as an example of using solid state power personal communication device, but it is not limited to such smartphone only. Control means in the form of a microcontroller 801 includes appropriate control circuitry and processing functionalities through other control units, such as flash card 806, bluetooth control 807, mobile DRAM 808, CMOS image sensor 809, touch screen control 810, security solution 811, baseband processor 812, multiple camera production 815, Wifi control 816, multimedia controller 817 and audio CODEC 818. The power source for smartphone is powered by a solid state battery/pack 803. The specific embodiment of current invention is implemented into the battery management system 802, which is controlling and monitoring the state of charge of the solid state battery/pack to achieve required power during the operation and prolong solid state battery/pack cycle life. External power source can be connected through the power supply unit 805 through the AC/DC converter 804 to recharge the solid state battery/pack.

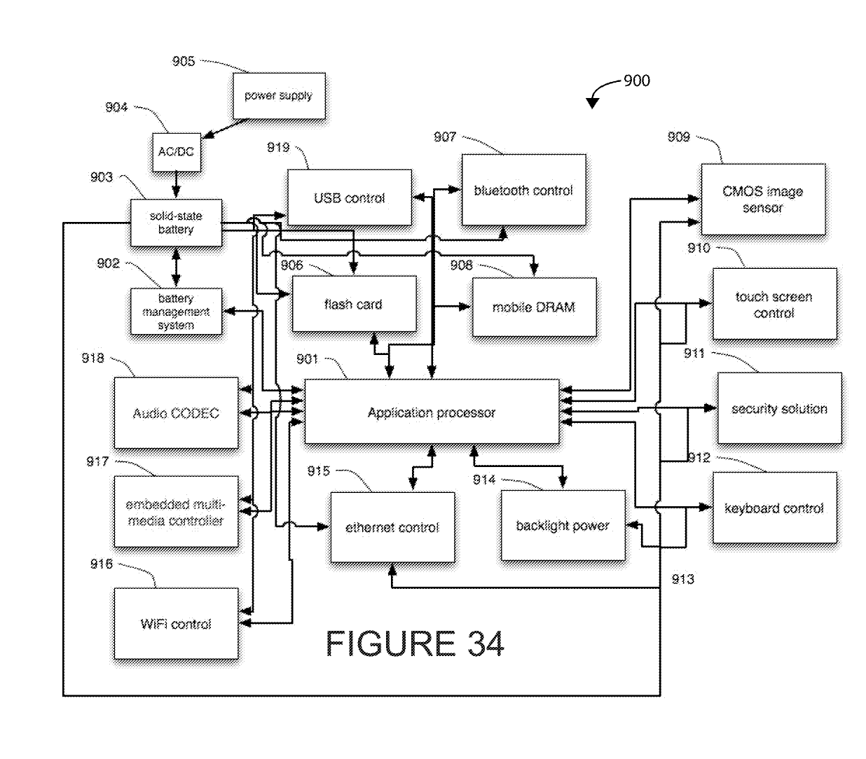

EXAMPLE 13 laptop/tablet, FIG. 34 shows schematically the control means of the laptop or tablet 900, and power supply means of such electrical appliance. This is as an example of using solid state power personal computing device, but it is not limited to laptop or tablet only. Control means in the form of a microcontroller 901 includes appropriate control circuitry and processing functionalities through other control units, such as flash card control 906, bluetooth control 907, mobile DRAM 908, CMOS image sensor 909, touch screen control 910, security solution 911, keyboard control 912, Ethernet control 915, Wifi control 916, multimedia controller 917, audio CODEC 918, and USB control 919. The power source for smartphone is powered by a solid state battery/pack 903. The specific embodiment of current invention is implemented into the battery management system 902, which is controlling and monitoring the state of charge of the solid state battery/pack to achieve required power during the operation and prolong solid state battery/pack cycle life. External power source can be connected through the power supply unit 905 through the AC/DC converter 904 to recharge the solid state battery/pack.

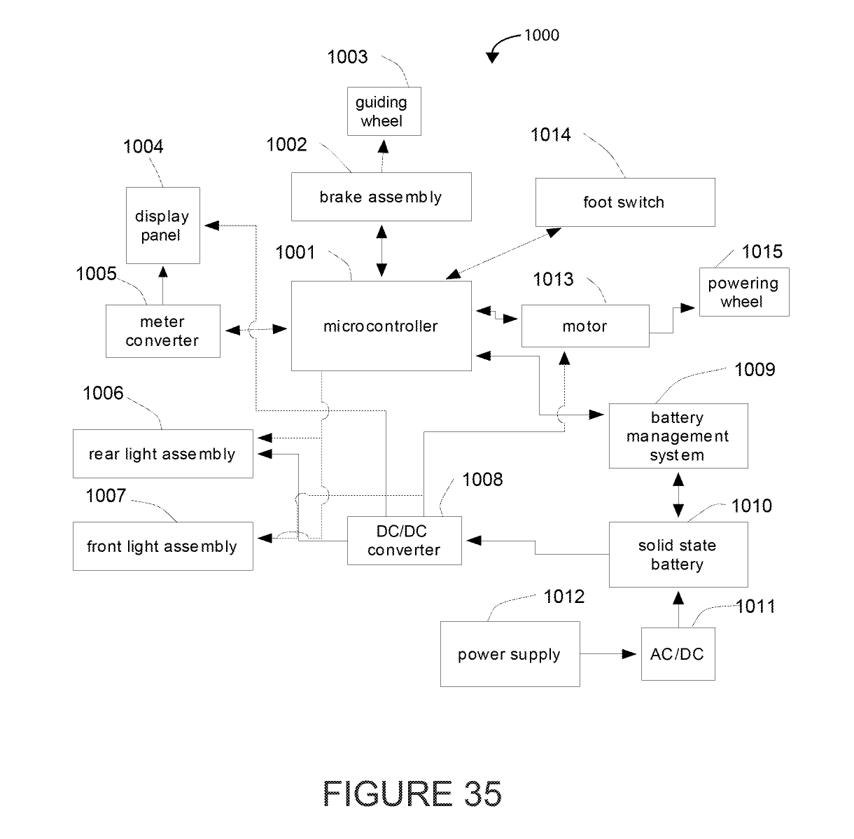

EXAMPLE 13 electric vehicle, FIG. 35 shows schematically the control means of the electric vehicle 1000, and power supply means of such vehicle. This is as an example of using solid state power transportation vehicle, but it is not limited to electric vehicle only. Control means in the form of a microcontroller 1001 includes appropriate control circuitry and processing functionalities through microcontroller 1001 to process signals received from foot switch 1004, rear light assembly 1012, front light assembly 1013, and brake assembly 1002. In electric vehicle, the main feedback control is provided the rider himself; therefore, the control algorithm is less sophisticated. The power source for electric scooter is powered by a solid state battery/pack 1010. The specific embodiment of current invention is implemented into the battery management system 1009, which is controlling and monitoring the state of charge of the solid state battery/pack to achieve required power during the operation and prolong solid state battery/pack cycle life. External power source can be connected through the power supply unit 1012, through the AC/DC converter 1011 to recharge the solid state battery/pack.

In one specific embodiment, cathode material of current invention comprise amorphous or crystalline lithiated or non-lithiated transition metal oxide and lithiated transition metal phosphate, wherein the metal is in Groups 3 to 12 in the periodic table, including but not limited to lithium manganese oxide, lithium nickel oxide, lithium cobalt oxide, lithium nickel-cobalt-manganese oxide, lithium nickel-cobalt-aluminum oxide, lithium copper-manganese oxide, lithium iron-manganese oxide, lithium nickel-manganese oxide, lithium cobalt-manganese oxide, lithium nickel-manganese oxide, lithium aluminum-cobalt oxide, lithium iron phosphate, lithium manganese phosphate, lithium nickel phosphate, lithium cobalt phosphate, vanadium oxide, magnesium oxide, sodium oxide, sulfur, metal (Mg, La) doped lithium metal oxides, such as magnesium doped lithium nickel oxide, lanthanum doped lithium manganese oxide, lanthanum doped lithium cobalt oxide. Electrolyte materials of current invention includes, but not limited to, lithiated oxynitride phosphorus (LIPON), poly(ethylene oxide) (PEO), lithium lanthanum zirconium oxide, lithium lanthanum titanium oxide, lithium sodium niobium oxide, lithium aluminum silicon oxide, lithium phosphate, lithium thiophosphate, lithium aluminum germanium phosphate, lithium aluminum titanium phosphate, LISICON (lithium super ionic conductor, generally described by LiₓM_{1-y}M′_{y}O₄ (M=Si, Ge, and M′=P, Al, Zn, Ga, Sb)), thio-LISICON (lithium super ionic conductor, generally described by LiₓM_{1-y}M′_{y}S₄ (M=Si, Ge, and M′=P, Al, Zn, Ga, Sb)), lithium ion conducting argyrodites (Li₆PS₅X (X═Cl, Br, I)), with ionic conductivity ranging from 10⁻⁵ to 10⁻¹ S/m. Anode materials of current invention comprises of amorphous or crystalline lithiated or non-lithiated transition metal oxide, including but not limited to lithium titanium oxide, germanium oxide, or graphite, lithium, silicon, antimony, bismuth, indium, tin nitride, or lithium alloys, including but not limited to lithium magnesium alloy, lithium aluminum alloy, lithium tin alloy, lithium tin aluminum alloy. Substrate materials of current invention comprises a polymer material, a polyethylene terephthalate (PET), PEN, a glass, an alumina, a silicon, an insulation coated metals, an anodized metals or a mica. The first barrier layer materials of current invention comprise at least oxides, nitride, and phosphate of metal in Groups 4, 10, 11, 13 and 14 of the periodic table, and wherein the barrier layer material comprises a LiₓPO_{y} where x+y<=7. The second barrier layer of current invention comprises an acrylate, acrylic ester and other polymers.

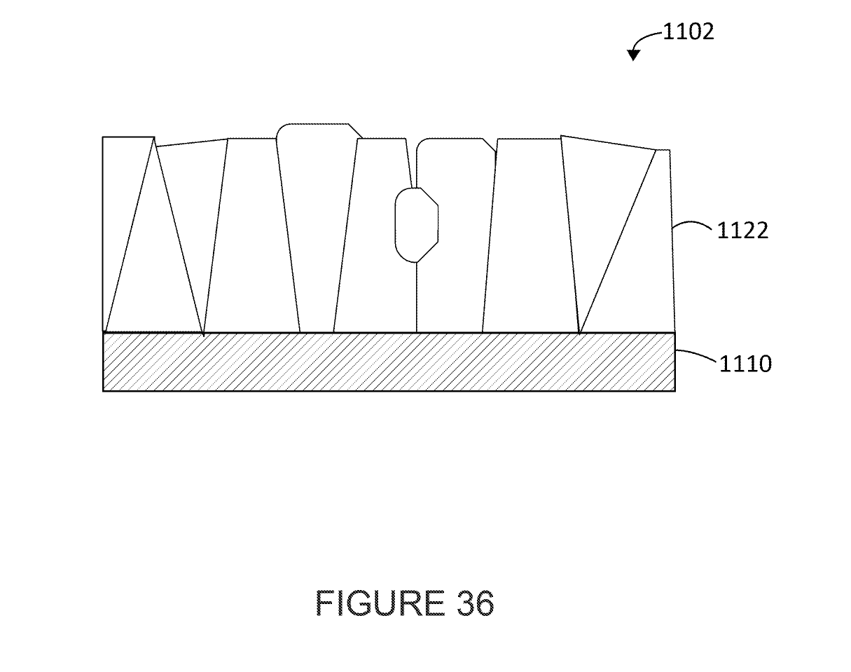

FIG. 36 is a simplified cross-sectional view of an illustration of an amorphous cathode material 1102 according to an embodiment of the present invention. As shown, the first thickness of amorphous cathode material 1122 overlying the second thickness of cathode material 1110 has a rough and irregular profile.

In an embodiment, the present invention provides a multi-layered solid-state battery device comprising: an equivalent circuit numbered from 1 through N associated with, respectively, a plurality of solid state battery cells numbered from 1 through N, each of the solid state battery cells comprising a first current collector overlying the substrate member, a cathode device overlying the first current collector, an electrolyte device overlying the cathode, an anode device overlying the electrolyte device, and a second current collector overlying the anode device, each of the plurality of solid state battery cells being operable at a state of charge between a lower bound to an upper bound; an energy density of greater than 50 watt hour per liter and greater characterizing the plurality of solid state battery cells; and a plurality of collimated pillar structures characterizing each of the cathode devices, each of the plurality of collimated pillar structures comprising an amorphous cathode material.

In a specific embodiment, the state of charge lower bound ranges from 0.5% to 75%, wherein the state of charge upper bound ranging from 25% to 99.5%. The cathode device can be characterized by an amorphous or crystalline structure. The cathode device can have a thickness ranging from 0.05 to 200 microns; and the anode device has a thickness ranging from 0.02 to 200 microns. The region of the cathode device can include a thickness ranging from about 0.05 to about 200 microns. The region can be substantially amorphous in characteristic. The anode device can include metal film. The plurality of battery cells can be wound or stacked.

In a specific embodiment, the solid state battery device can include a substrate made of at least one of a glass structure, a conductive structure, a metal structure, a ceramic structure, a plastic or polymer structure, or a semiconductor structure, or one or more active layers may comprise the substrate layer. The device can include a termination which is configured in a parallel or a serial arrangement using either a self-terminated or post-terminated connector configuration. The device can include a local conductivity characterizing the region of the cathode device and a bulk conductivity characterizing the cathode device.

In a specific embodiment, the cathode device is made from a material selected from lithiated or non-lithiated transition metal oxide and lithiated transition metal phosphate, wherein the metal is in Groups 3 to 12 in the periodic table, including but not limited to lithium manganese oxide, lithium nickel oxide, lithium cobalt oxide, lithium nickel-cobalt-manganese oxide, lithium nickel-cobalt-aluminum oxide, lithium copper-manganese oxide, lithium iron-manganese oxide, lithium nickel-manganese oxide, lithium cobalt-manganese oxide, lithium nickel-manganese oxide, lithium aluminum-cobalt oxide, lithium iron phosphate, lithium manganese phosphate, lithium nickel phosphate, lithium cobalt phosphate, vanadium oxide, magnesium oxide, sodium oxide, sulfur, metal (Mg, La) doped lithium metal oxides, such as magnesium doped lithium nickel oxide, lanthanum doped lithium manganese oxide, lanthanum doped lithium cobalt oxide.

In a specific embodiment, the anode device is made of a material selected from lithiated or non-lithiated transition metal oxide, including but not limited to lithium titanium oxide, germanium oxide, or graphite, lithium, silicon, antimony, bismuth, indium, tin nitride, or lithium alloys, including but not limited to lithium magnesium alloy, lithium aluminum alloy, lithium tin alloy, lithium tin aluminum alloy.

In a specific embodiment, the electrolyte device is selected from lithiated oxynitride phosphorus (LIPON), poly(ethylene oxide) (PEO), lithium lanthanum zirconium oxide, lithium lanthanum titanium oxide, lithium sodium niobium oxide, lithium aluminum silicon oxide, lithium phosphate, lithium thiophosphate, lithium aluminum germanium phosphate, lithium aluminum titanium phosphate, LISICON (lithium super ionic conductor, generally described by LiₓM_{1-y}M′_{y}O₄ (M=Si, Ge, and M′=P, Al, Zn, Ga, Sb)), thio-LISICON (lithium super ionic conductor, generally described by LiₓM_{1-y}M′_{y}S₄ (M=Si, Ge, and M′=P, Al, Zn, Ga, Sb)), lithium ion conducting argyrodites (Li₆PS₅X (X═Cl, Br, I)), with ionic conductivity ranging from 10⁻⁵ to 10⁻¹ S/m.

In a specific embodiment, each pair of the plurality of solid state battery cells comprises a bonding material in between. The cathode device can be characterized by a material comprising a plurality of pillar-like structures, each of which extends along a direction of the thickness, and substantially normal to a plane of the thickness of material and surface region. The cathode device can include a plurality of pillar structures, each of the pillar structure having a base region and an upper region, each of the pillar structures comprising a plurality of smaller particle-like structures, each of the smaller particle like structures being configured within each of the pillar structures. The cathode device can include a plurality of pillar structures, each of the pillar structure having a base region and an upper region, each of the pillar structures comprising a plurality of particle-like structures, each of the particle like structures being configured within each of the pillar structures, each pair of pillar structures having a plurality of irregularly-shaped polyhedral structures provided between the pair of pillar structures.

In an embodiment, the present invention provides a solid-state battery apparatus comprising: a plurality of battery cell devices, each of the devices having an anode device, an electrolyte device, and a cathode device; an equivalent circuit (EC) numbered from 1 through N characterizing the plurality of battery cells devices; a state of charge characterizing the plurality of battery cell devices; and a resistor, capacitor, or other electrical parameters provided in the equivalent circuit.

In a specific embodiment, the apparatus can include an appliance coupled to the plurality of battery cells, whereupon the application is selected from at least one of or more of at least a smartphone, a cell phones, personal digital assistants, radio players, music players, video cameras, tablet and laptop computers, military communications, military lighting, military imaging, satellite, aero-plane, satellites, micro air vehicles, hybrid electric vehicles, plug-in hybrid electric vehicles, fully electric vehicles, electric scooter, underwater vehicle, boat, ship, electric garden tractor, and electric ride on garden device, unmanned aero drone, unmanned aero-plane, an RC car, robotic toys, robotic vacuum cleaner, robotic garden tools, robotic construction utility, robotic alert system, robotic aging care unit, robotic kid care unit, electric drill, electric mower, electric vacuum cleaner, electric metal working grinder, electric heat gun, electric press expansion tool, electric saw and cutters, electric sander and polisher, electric shear and nibbler, electric routers, an electric tooth brush, an electric hair dryer, an electric hand dryer, a global positioning system (GPS) device, a laser rangefinder, a flashlight, an electric street lighting, standby power supply, uninterrupted power supplies, and other portable and stationary electronic devices

While the above is a full description of the specific embodiments, various modifications, alternative constructions and equivalents may be used. Therefore, the above description and illustrations should not be taken as limiting the scope of the present disclosure which is defined by the appended claims.

What is claimed is:

1. A multi-layered solid-state battery device comprising:
an equivalent circuit numbered from 1 through N associated with, respectively, a plurality of solid state battery cells numbered from 1 through N, each of the solid state battery cells comprising a first current collector overlying the substrate member, a cathode device overlying the first current collector, an electrolyte device overlying the cathode, an anode device overlying the electrolyte device, and a second current collector overlying the anode device, each of the plurality of solid state battery cells being operable at a state of charge between a lower bound to an upper bound;
an energy density of greater than 50 watt hour per liter and greater characterizing the plurality of solid state battery cells; and
a plurality of collimated pillar structures characterizing each of the cathode devices, each of the plurality of collimated pillar structures comprising an amorphous cathode material.

2. The device of claim 1 wherein the state of charge lower bound ranging from 0.5% to 75%, wherein the state of charge upper bound ranging from 25% to 99.5%.

3. The device of claim 1 wherein the cathode device is characterized by an amorphous or crystalline structure.

4. The device of claim 1 wherein the anode device comprises of metal film.

5. The device of claim 1 wherein the cathode device has a thickness ranging from 0.05 to 200 microns; and the anode device has a thickness ranging from 0.02 to 200 microns.

6. The device of claim 1 wherein the plurality of battery cells is wound or stacked.

7. The device of claim 1 further comprising a substrate made of at least one of a glass structure, a conductive structure, a metal structure, a ceramic structure, a plastic or polymer structure, or a semiconductor structure, or one or more active layers may comprise the substrate layer.

8. The device of claim 1 wherein the region of the cathode device comprises a thickness ranging from about 0.05 to about 200 microns.

9. The device of claim 1 wherein the region is substantially amorphous in characteristic.

10. The device of claim 1 further comprising a termination which is configured in a parallel or a serial arrangement using either a self-terminated or post-terminated connector configuration.

11. The device of claim 1 further comprising a local conductivity characterizing the region of the cathode device and a bulk conductivity characterizing the cathode device.

12. The device of claim 1 wherein the cathode device is made from a material selected from lithiated or non-lithiated transition metal oxide and lithiated transition metal phosphate, wherein the metal is in Groups 3 to 12 in the periodic table, including but not limited to lithium manganese oxide, lithium nickel oxide, lithium cobalt oxide, lithium nickel-cobalt-manganese oxide, lithium nickel-cobalt-aluminum oxide, lithium copper-manganese oxide, lithium iron-manganese oxide, lithium nickel-manganese oxide, lithium cobalt-manganese oxide, lithium nickel-manganese oxide, lithium aluminum-cobalt oxide, lithium iron phosphate, lithium manganese phosphate, lithium nickel phosphate, lithium cobalt phosphate, vanadium oxide, magnesium oxide, sodium oxide, sulfur, metal (Mg, La) doped lithium metal oxides, such as magnesium doped lithium nickel oxide, lanthanum doped lithium manganese oxide, lanthanum doped lithium cobalt oxide.

13. The device of claim 1 wherein the anode device is made of a material selected from lithiated or non-lithiated transition metal oxide, including but not limited to lithium titanium oxide, germanium oxide, or graphite, lithium, silicon, antimony, bismuth, indium, tin nitride, or lithium alloys, including but not limited to lithium magnesium alloy, lithium aluminum alloy, lithium tin alloy, lithium tin aluminum alloy.

14. The device of claim 1 wherein the electrolyte device is selected from lithiated oxynitride phosphorus (LIPON), poly(ethylene oxide) (PEO), lithium lanthanum zirconium oxide, lithium lanthanum titanium oxide, lithium sodium niobium oxide, lithium aluminum silicon oxide, lithium phosphate, lithium thiophosphate, lithium aluminum germanium phosphate, lithium aluminum titanium phosphate, LISICON (lithium super ionic conductor, generally described by LiₓM_{1-y}M′_{y}O₄ (M=Si, Ge, and M′=P, Al, Zn, Ga, Sb)), thio-LISICON (lithium super ionic conductor, generally described by LiₓM_{1-y}M′_{y}S₄ (M=Si, Ge, and M′=P, Al, Zn, Ga, Sb)), lithium ion conducting argyrodites (Li₆PS₅X (X═Cl, Br, I)), with ionic conductivity ranging from 10⁻⁵ to 10⁻¹ S/m.

15. The device of claim 1 wherein each pair of the plurality of solid state battery cells comprises a bonding material in between.

16. The device of claim 1 wherein the cathode device is characterized by a material comprising a plurality of pillar-like structures, each of which extends along a direction of the thickness, and substantially normal to a plane of the thickness of material and surface region.

17. The device of claim 1 wherein the cathode device comprises a plurality of pillar structures, each of the pillar structure having a base region and an upper region, each of the pillar structures comprising a plurality of smaller particle-like structures, each of the smaller particle like structures being configured within each of the pillar structures.

18. The device of claim 1 wherein the cathode device comprises a plurality of pillar structures, each of the pillar structure having a base region and an upper region, each of the pillar structures comprising a plurality of particle-like structures, each of the particle like structures being configured within each of the pillar structures, each pair of pillar structures having a plurality of irregularly-shaped polyhedral structures provided between the pair of pillar structures.

19. A solid-state battery apparatus comprising:
a plurality of battery cell devices, each of the devices having an anode device, an electrolyte device, and a cathode device;
an equivalent circuit (EC) numbered from 1 through N characterizing the plurality of battery cells devices;
a state of charge characterizing the plurality of battery cell devices; and
a resistor, capacitor, or other electrical parameters provided in the equivalent circuit.

20. The apparatus of claim 1 further comprising an appliance coupled to the plurality of battery cells, whereupon the application is selected from at least one of or more of at least a smartphone, a cell phones, personal digital assistants, radio players, music players, video cameras, tablet and laptop computers, military communications, military lighting, military imaging, satellite, aero-plane, satellites, micro air vehicles, hybrid electric vehicles, plug-in hybrid electric vehicles, fully electric vehicles, electric scooter, underwater vehicle, boat, ship, electric garden tractor, and electric ride on garden device, unmanned aero drone, unmanned aero-plane, an RC car, robotic toys, robotic vacuum cleaner, robotic garden tools, robotic construction utility, robotic alert system, robotic aging care unit, robotic kid care unit, electric drill, electric mower, electric vacuum cleaner, electric metal working grinder, electric heat gun, electric press expansion tool, electric saw and cutters, electric sander and polisher, electric shear and nibbler, electric routers, an electric tooth brush, an electric hair dryer, an electric hand dryer, a global positioning system (GPS) device, a laser rangefinder, a flashlight, an electric street lighting, standby power supply, uninterrupted power supplies, and other portable and stationary electronic devices.
